(19) United States
(12) Patent Application Publication
(10) Pub. No.: US 2018/0144531 A1
(43) Pub. Date: May 24, 2018

(54) ANIMATING A VIRTUAL OBJECT IN A VIRTUAL WORLD

(71) Applicant: NaturalMotion Limited, Oxford (GB)

(72) Inventor: Alberto Aguado, Aston, Oxfordshire (GB)

(21) Appl. No.: 15/574,466

(22) PCT Filed: May 22, 2015
(86) PCT No.: PCT/EP2015/061416

§ 371 Date: Nov. 15, 2017

(51) Int. Cl. G06T 13/40; G06T 19/20; G06T 19/00

(52) U.S. Cl. CPC G06T 13/40; G06T 19/003; G06T 19/20

(57) ABSTRACT

A method of animating a virtual object within a virtual world, the method comprising: obtaining, for one or more object parts of a virtual object, a corresponding target, the virtual object comprising a plurality of object parts; at each animation update step of a sequence of one or more animation update steps: for each of the one or more object parts, performing a corresponding dynamics calculation to determine a corresponding effector for that object part, the dynamics calculation based, at least in part, on the corresponding target for that object part; and performing an inverse kinematics operation, based on the effector determined for each of the one of more object parts, to update a configuration for the plurality of object parts.

### TECHNICAL FIELD

The invention relates to the technical field of the animation of a virtual object in a virtual world.

### BACKGROUND

It is known to author or generate animation for one or more virtual objects (also termed “characters”) that are located in a virtual environment (or virtual world), such as a three dimensional virtual environment of a video game or of a visual effects tool. The characters can consist of a hierarchy of joints, or a “rig”, that form a skeleton. A skin or mesh may be overlaid (or rendered) on top of the rig to thereby visually represent the character. By updating the location and orientation of the joints (i.e. changing the geometric configuration of the rig), the posture of the character and the position of the character within the virtual world may be updated, i.e. the character may be animated.

A character may also have an associated physics definition so that a physics simulation can be performed (e.g. using an engine or module that simulates one or more laws of physics, such as gravity)—this physics simulation can then be used to influence the movement of the character and/or the character's physical interaction with the virtual world or other characters/objects within the virtual world (e.g. to determine how the character should be animated, or should respond, to a collision with another object).

A number of different animation techniques exist, such as:
Forward kinematics animation—this involves specifying particular angles/orientations for the joints of the rig. This does not involve the physics simulation. Such animation often does not look realistic and is difficult to control.
inverse kinematics animation—this involves: (a) specifying desired target locations and/or orientations for one or more joints of the rig; (b) performing an inverse kinematics operation that determines angles/orientations for the joints of the rig in order to achieve those target locations and/or orientations (e.g. given a target location at which it is desired for a simulated human character to place a foot, the inverse kinematics animation then determines the angles/orientations for the joints of the rig for that character in order to try to achieve a posture for the character such that the foot is then placed at the target location); and (c) setting the angles/orientations for the joints of the rig to the determined angles/orientations. Again this does not involve the physics simulation. Whilst inverse kinematics animation is easier to control than just forward kinematics animation on its own, it may not look as realistic as other animation methods.
Dynamics animation—this involves the use of the above-mentioned physics simulation, which may, for example, involve the simulated application of forces and/or torques to various parts of the characters in order to determine how the character would respond under one or more simulated laws of physics. Whilst dynamics animation may result in a more natural looking animation, the processing requirements for the physics simulation are often significantly greater than the processing requirements for inverse-kinematics. Additionally, dynamics animation is often more difficult to control than inverse-kinematics.

### BRIEF DESCRIPTION OF THE DRAWINGS

Embodiments will now be described, by way of example only, with reference to the accompanying drawings, in which:

FIG. 1 schematically illustrates an example of a computer system;

FIG. 2 schematically illustrates example virtual objects within a virtual world;

FIG. 3 schematically illustrates an object for an animation according to an embodiment;

FIG. 4 schematically illustrates a compound object;

FIG. 5 schematically illustrates regions around joints of the object of FIG. 3 as defined by physical data for the object of FIG. 3;

FIG. 6 schematically illustrates some of the data that may be stored in a memory of the computer system of FIG. 1 for embodiments;

FIGS. 7A and 7B schematically illustrate a control frame and an effector frame for an object part;

FIG. 8 schematically illustrates an example system for animating a virtual object according an embodiment;

FIG. 9 is a flowchart illustrating a method for animating an object using the system of FIG. 8 according to an embodiment;

FIG. 10 schematically illustrates an example of the application of the method of FIG. 9 in respect of a joint of an object;

FIG. 11 schematically illustrates a method for generating effector data based on target data 810 according to an embodiment;

FIG. 12 schematically illustrates a method for performing a dynamics calculation in order to generate or determine an effector based on a target according to an embodiment;

FIGS. 13a, 13b, 13c and 13d are graphs showing examples results of the dynamics calculation of FIG. 12;

FIG. 14 schematically illustrates how the a spring constant and a damping coefficient affect lag and overshoot;

FIG. 15 illustrates examples of how the value for an effector's x, y or z coordinate or orientation angle may change over a sequence of animation update steps;

FIGS. 16a and 16b schematically illustrate the effect of a dynamics parameter D; and

FIG. 17 schematically illustrates the effect of a dynamics parameter L.

### DETAILED DESCRIPTION

It would be desirable to be able to perform animation in a more easily controllable manner (such as that provided by inverse kinematics) whilst, at the same time, providing more realistic/natural-looking animations (such as those provided by dynamics animation) but without having to incur the more substantial processing overhead of dynamics animation.

Embodiments effectively use inverse kinematics, but use dynamics/physics calculations to control the inputs to the inverse kinematics processing. The amount of processing performed for these dynamics/physics calculations is substantially less than that used when performing normal dynamics animation (since the number of calculations is much less, e.g. calculations are only needed in respect of particular desired targets to be achieved, as opposed to calculations across the whole of the character's rig). Control is maintained by virtue of being able to specify targets (by virtue of so-called behaviours) in the same way as for normal inverse kinematics. The use of the dynamics/physics calculations to control or generate the inputs to the inverse kinematics results in more natural/realistic-looking animations.

In the description that follows and in the figures, certain embodiments are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### 1—SYSTEM OVERVIEW

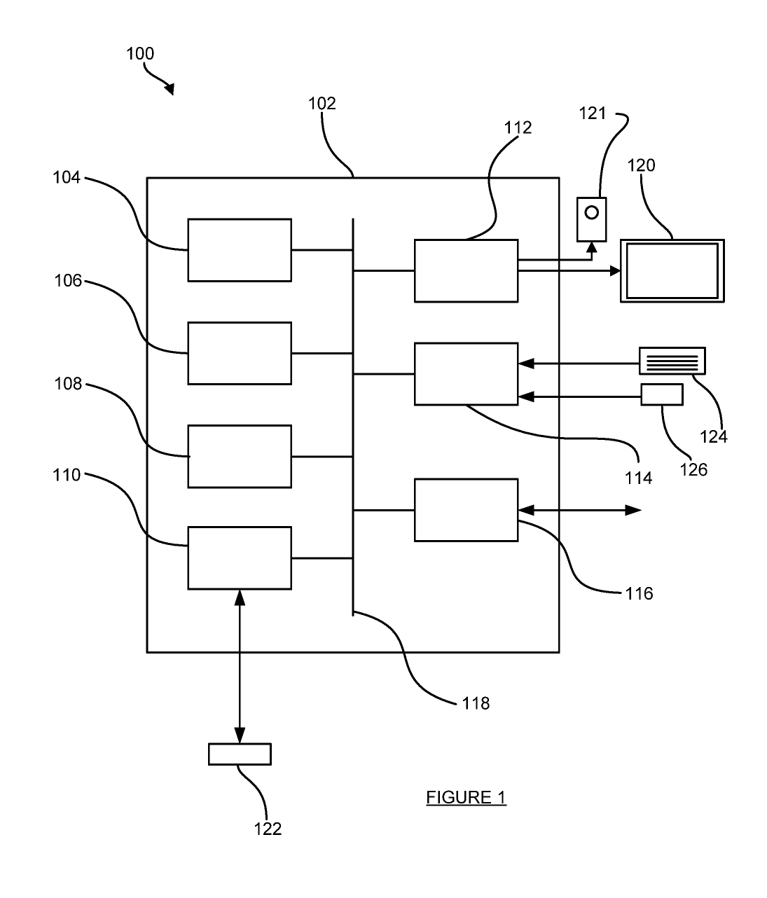

FIG. 1 schematically illustrates an example of a computer system 100. The system 100 comprises a computer 102. The computer 102 comprises: a storage medium 104, a memory 106, a processor 108, an interface 110, a user output interface 112, a user input interface 114 and a network interface 116, which are all linked together over one or more communication buses 118.

The storage medium 104 may be any form of non-volatile data storage device such as one or more of a hard disk drive, a magnetic disc, an optical disc, a ROM, etc. The storage medium 104 may store an operating system for the processor 108 to execute in order for the computer 102 to function. The storage medium 104 may also store one or more computer programs (or software or instructions or code).

The memory 106 may be any random access memory (storage unit or volatile storage medium) suitable for storing data and/or computer programs (or software or instructions or code).

The processor 108 may be any data processing unit suitable for executing one or more computer programs (such as those stored on the storage medium 104 and/or in the memory 106), some of which may be computer programs according to embodiments or computer programs that, when executed by the processor 108, cause the processor 108 to carry out a method according to an embodiment and configure the system 100 to be a system according to an embodiment. The processor 108 may comprise a single data processing unit or multiple data processing units operating in parallel, separately or in cooperation with each other. The processor 108, in carrying out data processing operations for embodiments, may store data to and/or read data from the storage medium 104 and/or the memory 106.

The interface 110 may be any unit for providing an interface to a device 122 external to, or removable from, the computer 102. The device 122 may be a data storage device, for example, one or more of an optical disc, a magnetic disc, a solid-state-storage device, etc. The device 122 may have processing capabilities for example, the device may be a smart card. The interface 110 may therefore access data from, or provide data to, or interface with, the device 122 in accordance with one or more commands that it receives from the processor 108.

The user input interface 114 is arranged to receive input from a user, or operator, of the system 100. The user may provide this input via one or more input devices of the system 100, such as a mouse (or other pointing device) 126 and/or a keyboard 124, that are connected to, or in communication with, the user input interface 114. However, it will be appreciated that the user may provide input to the computer 102 via one or more additional or alternative input devices (such as a touch screen). The computer 102 may store the input received from the input devices via the user input interface 114 in the memory 106 for the processor 108 to subsequently access and process, or may pass it straight to the processor 108, so that the processor 108 can respond to the user input accordingly.

The user output interface 112 is arranged to provide a graphical/visual and/or audio output to a user, or operator, of the system 100. As such, the processor 108 may be arranged to instruct the user output interface 112 to form an image/video signal representing a desired graphical output, and to provide this signal to a monitor (or screen or display unit) 120 of the system 100 that is connected to the user output interface 112. Additionally or alternatively, the processor 108 may be arranged to instruct the user output interface 112 to form an audio signal representing a desired audio output, and to provide this signal to one or more speakers 121 of the system 100 that is connected to the user output interface 112.

Finally, the network interface 116 provides functionality for the computer 102 to download data or computer code from and/or upload data or computer code to one or more data communication networks.

It will be appreciated that the architecture of the system 100 illustrated in FIG. 1 and described above is merely exemplary and that other computer systems 100 with different architectures (for example with fewer components than shown in FIG. 1 or with additional and/or alternative components than shown in FIG. 1) may be used in embodiments. As examples, the computer system 100 could comprise one or more of: a personal computer; a server computer; a mobile telephone; a tablet; a laptop; a television set; a set top box; a games console; other mobile devices or consumer electronics devices; etc.

### 2—ANIMATIONS AND DATA FOR ANIMATIONS

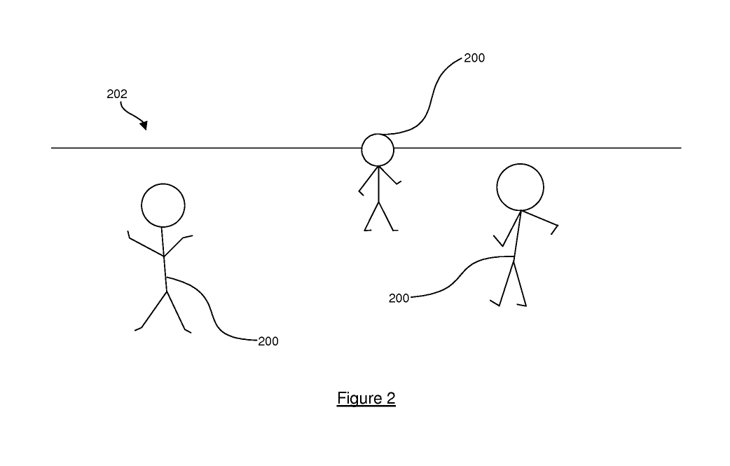

Embodiments are concerned with animations and, in particular, an animation of a virtual object (or a character) that is located (or resides) within a virtual world (or environment). FIG. 2 schematically illustrates three example virtual objects 200 within a virtual world 202. The virtual objects 200 shown in FIG. 2 (and the rest of this application) represent human beings, but it will be appreciated that embodiments are equally applicable to animations of virtual objects that represent other articles, items, animals, etc. and other types, structures and forms of object that have different intended representations. The virtual world 202 may be any virtual environment, arena or space containing the virtual objects 200 and in which the virtual objects 200 may be moved or animated. Thus, the virtual world 202 may represent a real-world location, a fictitious location, a building, the outdoors, underwater, in the sky, a scenario/location in a game or in a movie, etc. The animation of the virtual object 200 may form a part of a computer game being executed by the processor 108 of the computer system 100, with the animation being generated/computed in real-time. The animation of the virtual object 200 may be generated/computed so as to output a video animation to form part of a film/movie (in which case the generation/computation need not be in real-time). The animation of the virtual object 200 may be generated/computed for other purposes (e.g. computer simulations that involve objects moving and interacting in an environment).

An animation for an object 200 comprises performing an update process at each time point (also referred to as an animation update step) in a series of time points (or a series of animation update steps or update time points). These time-points may correspond to video frames, video fields, or any other time or display frequency of interest—for the rest of this description, the time-points shall be assumed to correspond to video frames, but it will be appreciated that this is only an example and should not be taken as limiting. For example, in some embodiments, one or more animation update steps may be carried out between successive video frames/fields and this number may or may not be constant over time. It will be appreciated that the display frequency (i.e. the frequency at which a display process displays or renders an image of the virtual world 202) need not necessarily be linked to the frequency of performing the update process. The update process performed at the animation update step updates values for attributes of (or associated with) the object 200. These attributes may correspond to, for example, the location and/or orientation of one or more object parts of the object 200 (e.g. the location and/or orientation of the limbs, neck, digits, head, etc. of a human object 200). Thus, in updating the values for the location and/or orientation object attributes, the object 200 is moved within the virtual world 202. However, the attributes associated with the object 200 are not limited to location and/or orientation object attributes, as discussed below.

In the embodiments described below, the animations relate to so-called “skeletal animation”, but it will be appreciated that different types or styles of animation fall within the scope of the present invention. The object attributes for an object 200 may be represented by some or all of the following data (depending on the type of animation and how the object 200 and its attributes are to be represented): (a) topological data; (b) geometric data; (c) physical data; (d) trajectory data; (e) skinning data; and (f) rendering data. These data are described in more detail below. It will be appreciated that the object 200 may have attributes in addition to, or as alternatives to, the attributes as described further below with reference to the various data (a)-(f).

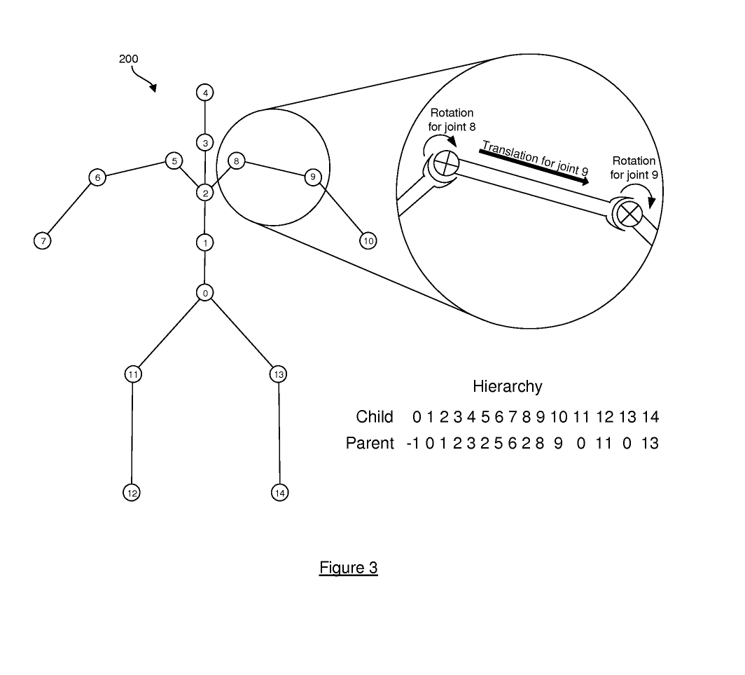

FIG. 3 schematically illustrates an object 200 for an animation according to an embodiment. The object 200 comprises a plurality of object sections (or “bones”) linked together by respective joints. In FIG. 3, the sections of the object 200 are the straight lines whilst the joints of the object 200 are the numbered circles.

In general, a joint is a (simulated) point or surface or location of contact between two or more object sections so that that joint links (or creates an association between) those sections. In other words, such a joint forms a simulated connection or tie between object sections (in the same way that, for example, a forearm is connected to an upper arm by virtue of an elbow joint). In this way, an object section may have one or more joints associated with it. A joint normally occurs at an end of the object section(s) it is associated with.

Some joints (such as joint 10 in FIG. 3) occur at the end of an object section, but do not link that section to another section. These joints merely serve to indicate the location of the free (i.e. unconnected) end of that section.

In some embodiments, each object section is “rigid” in that the distance between the joints associated with that section is constant, although, of course, each rigid section may have its own length/distance which may be different from the length/distance for the other rigid sections. However, it will be appreciated that in other embodiments one or more of the sections of the object 200 may not be “rigid”.

The object 200 may therefore be considered to comprise a plurality of object parts. In some embodiments, the topological data represents the object 200 as a plurality of joints (i.e. the object parts are just the joints). In some embodiments, the topological data represents the object 200 as a plurality of object sections (i.e. the object parts are just the bones). In some embodiments, the topological data represents the object 200 as a plurality of joints together with a plurality of object sections. The actual representation does not matter for embodiments and therefore in this description the topological data shall represent the object 200 as a plurality of joints and it will be appreciated that the use herein of the term “joint” encompasses both joints and/or bones unless stated otherwise or unless clearly not appropriate. However, the skilled person will appreciate that the following description may be applied analogously to the alternative styles of representation.

The object parts may be considered as forming a skeleton, or framework or “rig”, for the object 200.

The object parts (joints in this representation) are linked together, or are associated with each other, in a hierarchy. The hierarchy of joints illustrated in FIG. 3 may be represented by table 1 below:

TABLE 1

| Joint ID | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| Parent ID | −1 | 0 | 1 | 2 | 3 | 2 | 5 | 6 | 2 | 8 | 9 | 0 | 11 | 0 | 13 |

In this hierarchy of joints for the object 200, each joint, other than a central, basis root joint (labelled with a joint ID of 0) is a child of another joint in the hierarchy, i.e. every joint other than that root joint is associated with (or linked to) a second joint in the hierarchy (by virtue of a connecting object section), where that second joint is considered to be the parent of that joint. The fact that the central joint is not a child of another joint (and therefore has no parent joint) is represented in table 1 by indicating a parent ID of −1. For example, joint 2 is a child of joint 1 and itself has three children, namely joints 3, 5 and 8. As another example, joint 10 is a child of joint 9, but has no children itself. A joint such as joint 10 that has no child joints (i.e. a joint that is not itself a parent) is included so as to represent a “terminating end” of a section of the object 200, i.e. to indicate the location of the extremities of the object 200. Due to the connecting nature of the object sections that link joints, the movement, position and orientation of a joint in the virtual world 202 is affected by the movement, position and orientation of the parent of that joint in the virtual world 202.

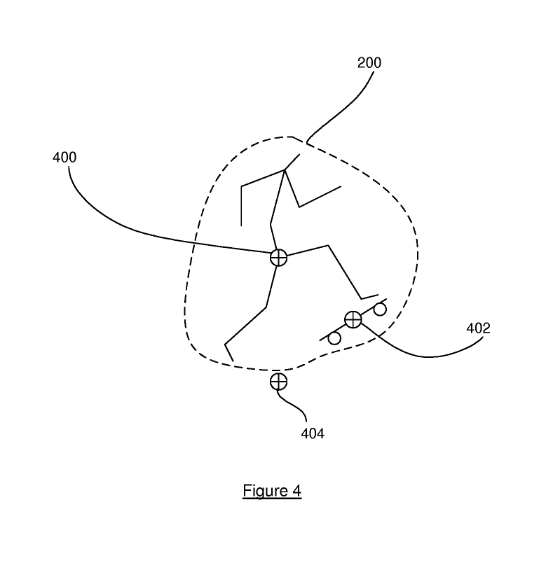

An object may have multiple root joints. For example, FIG. 4 schematically illustrates a compound object 200 representing a person on a skateboard. This may be considered as being one object as the person and the skateboard may be considered to be one set of semantically linked data (i.e. a single character). However, as the person and the skateboard are not rigidly or permanently attached to each other, they each have their own root joints, namely a root joint 400 for the person and a root joint 402 for the skateboard. The joints for the person will then be hierarchically related to the root joint 400, whilst the joints for the skateboard will be hierarchically related to the root joint 402.

The topological data for the object 200 is data that represents this hierarchy (or hierarchies) or structure of the object parts, i.e. data defining the parent-child relationships between the various object parts that make up the object 200. For example, the topological data for the object 200 may be stored in the form of table 1 above.

The geometric data for the object 200 represents the relative positions and orientations of the object parts. The values given to the geometric data represent the positioning or configuration of the object 200 in a particular posture or stature. In effect, the attributes for the object 200 represented by the geometric data are the length of each object section (bone) together with that bone's orientation relative to its parent bone, i.e. this geometric data represents the distance between a joint and its parent joint, together with the orientation of that joint relative to the parent joint. There are many well-known ways of representing this geometric data, such as: (a) using respective transformation matrices for the joints; (b) using respective pairs of 3×3 rotation matrices and 1×3 translation matrices; or (c) using respective quaternions. As these methods are well-known, and as the particular method used is not important for embodiments, these methods shall not be described in more detail herein. An example representing some of the geometric data for joints 8 and 9 is shown in FIG. 3.

The geometric data for a particular joint is normally defined in a coordinate space local to the parent of that joint (i.e. in which that parent is fixed). Thus, for example, if a “shoulder joint” 8 of FIG. 3 moves but the “elbow joint” 9 of FIG. 3 does not move relative to the shoulder joint, then the geometric data 308 for the elbow joint would not change.

The attribute of the object 200 represented by the trajectory data is the location and orientation in the virtual world 202 of a so-called “trajectory joint” 404 for the object 200 (shown in FIG. 4 but not shown in FIG. 3). The trajectory joint 404 is used as a representative location of the object 200 within the world 202. Thus, different values for the trajectory data place the trajectory joint 404 (and hence the object 200) at different locations in the virtual world 202.

The trajectory joint 404 is usually not an actual joint of the object 200 (i.e. it need not form part of the structure of the object 200), but is simply a position and orientation within the world 202 to represent the overall location and orientation for the object 200. For convenience, the trajectory joint 404 may be represented as a “special” joint within the hierarchy represented by the topological data. The trajectory joint 404 need not be a root joint (with no parent) but can be located anywhere within the skeleton topology as represented by the topological data. However, it is generally the location and orientation of the joints of the object 200 (as specified by virtue of the topological data and the geometric data) relative to the trajectory joint 404 that is important as this results in a particular joint or object section being at a particular/absolute position and orientation within the entire virtual world 202. One way of viewing or implementing this is for all joints of the object 200 (as specified by the topological data), including root joints, to be ultimately parented to the trajectory joint 404 so that their location and orientation within the virtual world 202 can be calculated based on the trajectory data, the topological data and the geometric data.

The orientation of a trajectory joint 404 is just as important as its position, as it represents the overall direction that the object 200 is “facing”.

The physical data represents various physical attributes (or “properties”) for the object 200. These physical attributes represent or impose various physical properties or restrictions or limitations on the object 200. Typically, subsets of the physical data are associated with respective joints represented by the topological data. For example, one or more of the joints (or bones) represented by the topological data may have corresponding physical data representing attributes such as:
Size and shape of a region around that joint. The region may be a capsule or a cylinder, with the size and shape being defined by lengths and radii accordingly. The region may represent the body, or the “bulk”, of the object 200 that is supported by the framework of bones and joints. If another object 200 were to enter, penetrate or perhaps even just contact this region, then the two objects 200 may be considered to have collided. FIG. 5 schematically illustrates such regions 500 for the joints for the object 200.
A mass for the joint.
An inertia property for the joint.
Other properties of the joint such as stiffness, damping factors, type of joint. For example, the “shoulder” joint 8 in FIG. 5 may be a ball-and-socket joint whilst the “elbow” joint 9 in FIG. 5 may be a hinge joint. Such data may therefore restrict or constrain how one joint may move (e.g. hinge and/or rotate and/or pivot) with respect to another joint (a parent or a child joint).

However, as shown in FIG. 5, some of the joints 502 represented by the topological data may not have corresponding physical attributes.

The skinning data is data that enables so-called “skinning” for the animation. The process of skinning is well-known in this field of technology and shall not be described in more detail herein—it takes a definition of the surface of the object 200 and attaches it to the skeleton formed by the object parts (the joints and/or bones). The skinning data is therefore data defining this object surface, which is an attribute of the object 200.

The rendering data is data that enables so-called “rendering” of the animation. The process of rendering is well-known in this field of technology and shall not be described in more detail herein—it actually outputs or displays the skinned surface with relevant textures, colours, lighting, etc. as appropriate. The rendering data is therefore data defining the textures, colours, lighting, etc., which are attributes of the object 200.

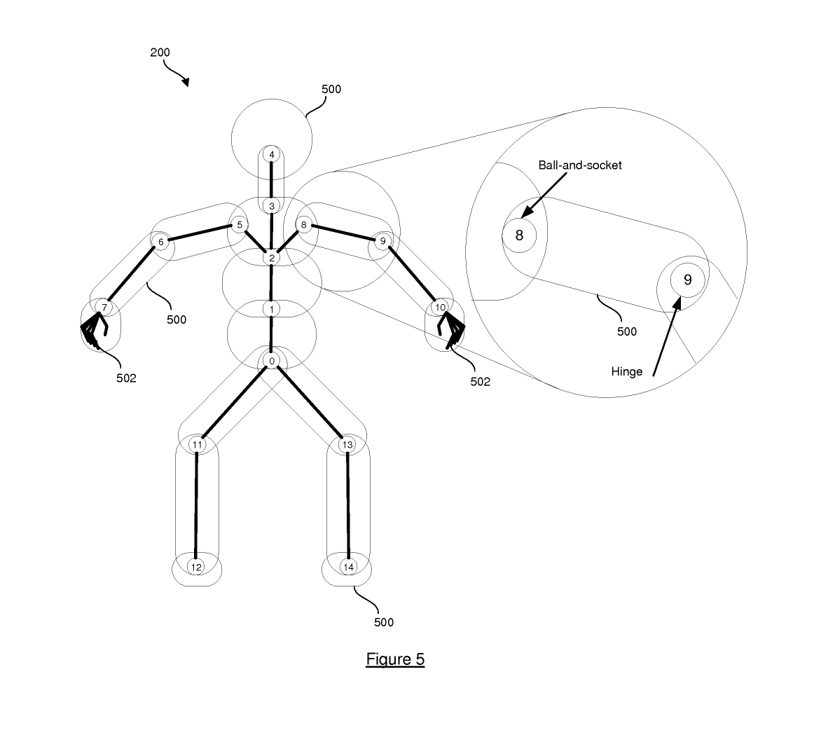

FIG. 6 schematically illustrates some of the data that may therefore be stored in the memory 106 (or additionally or alternatively stored in the storage medium 104 or the data storage device 122, or which may be accessible via the network interface 116). There may be respective data 600 for one or more objects 200—in FIG. 6, there are n objects 200, each with their own data 600-1, 600-2, . . . , 600-n. The data 600 for an object 200 may include a set 602 of attribute data for that object 200, including one or more of: topological data 608; geometric data 610; trajectory data 612; physical data 614; skinning data 616; rendering data 618; and other data 620 specific to that object (e.g. a type of the object 200). There may also be stored other data 622 (such as data defining a time within a computer game or a movie; data defining or describing the virtual world 202; etc.) which is not specific to any one particular object 200.

The data 600 may comprise so-called “tag” data—this tag data may, for example, form part of the topological data 608 (for example stored in table 1 above) or may form part of the other data 620. In particular, the tag data may, for one or more joints or bones of the object 200, specify or associate a corresponding name (such as a string of characters, letters, etc.) for that joint or bone (for example, associating the name “knee” with a joint that is intended to be a knee joint of an object 200, such as the joints 11 and 13 in FIG. 3, or associating the name “left shoulder” with a joint that is intended to be a left shoulder joint of an object 200, such as the joint 5 in FIG. 3). In this way, different objects 200 that have different topology and networks of joints can have “common” joints identified—for example, a horse object 200 and an eagle object 200 will have different topologies and networks of joints, but both can have tag data that identifies particular joints as “shoulder” joints, in which case actions (such as behaviours as discussed below) can be defined for a “shoulder”, where these actions (or behaviours) can be defined and applied or used regardless of, or independent of, the topology of joints for an object 200, provided that that object 200 has tag data identifying one or more joints as a “shoulder” joint.

### 3—INVERSE KINEMATICS AND EFFECTORS

“Effectors” and “inverse kinematics” are well-known in this field of technology, but as embodiments relate to the use of effectors and inverse kinematics (referred to herein as IK), they shall be described in more detail below. However, it will be appreciated that the skilled person would be aware of effectors and IK and any known aspects of effectors and inverse kinematics that are not set out below.

An effector is a constraint or target or goal to be achieved by the IK processing. An effector is related to (or associated with, or defined/specified for) a corresponding joint of the object 200. An effector for a joint may represent a desired position and/or orientation for (or associated with) that joint of the object 200 (for example, defined either within the virtual world 202 or relative to the object 200 or relative to that joint). Examples include:
In the animation of the compound object 200 representing a person on a skateboard illustrated in FIG. 4, effectors might be specified for joints in the feet of the person which constrain the joints in the feet of the person so that, during the animation, the soles of the feet of the person should remain coincident with and parallel to the upper surface of the skateboard in order to represent “basic” skateboarding.
In the animation of an object 200 representing a person moving (e.g. walking) through the virtual world 202, an effector might be specified for a neck joint and/or a head joint of the person which constrains the orientation of the neck and/or head joints so that the head faces in a particular direction, i.e. so that, during the animation, the person appears to be looking at a fixed point within the virtual world 202.
In the animation of an object 200 representing a person, an effector may be specified for a hand joint of the person, where the effector specifies that, during the animation, the hand should be moved to a particular location within the virtual world 202 (e.g. to move towards a simulated button in the virtual world 202 so as to then press that button).
In the animation of an object 200 representing a person, an effector may be specified for a hand joint of the person, where the effector specifies that, during the animation, the hand should point towards another object in the virtual world 202, which may be a moving object (so as to “track” that moving object).

It will be appreciated there are many other types of effector that might be specified for an animation and that the above are provided merely as examples to help demonstrate the notion of an effector.

It is possible that a joint of the object 200 may have no effectors specified. It is possible that a joint of the object 200 may have a single effector specified. It is also possible that a joint for an object 200 may have a plurality of effectors specified.

It is possible that two or more effectors (either for the same joint or for different joints) may conflict with each other. For example, the “left elbow” joint of a person object 200 may have an effector which specifies that the left elbow should move a first distance to the left in the virtual world 202, whilst the “right elbow” joint of the person object 200 may have an effector which specifies that the right elbow should move a second distance to the right in the virtual world 202, and it is possible that, given the physical data for the object 200, it is not possible to move the left elbow the first distance to the left whilst also moving the right elbow the second distance to the right. As another example, at a particular point during a computer game, a hand joint of a game character in the computer game may have a first effector specifying that the right hand joint should point in a particular direction (e.g. to aim a gun at a target) and a second effector specifying that the right hand joint should move to the left shoulder (e.g. because the character has just been shot in the left shoulder and wishes to grasp the wound). To assist with such conflicts, in some embodiments, a weighting may be associated with each effector which indicates the relative importance of that effector to achieving an animation goal. With the first example above, the effector to move the left elbow might have a weight of 0.2 and the effector to move the right elbow might have a weight of 0.8, so that the person object 200 will move to the right, but not quite so much as if the effector for the left elbow had not been specified. With the second example above, the second effector to move the right hand joint to the left shoulder might be arranged to override the first effector to point the right hand in a particular direction (as grasping a wound might be viewed as more critical than aiming a weapon).

It will be appreciated that effectors may be generated dynamically, for example: depending on events that occur during a computer game or animation simulation, or based on commands that are issued by a user (e.g. when a player of a game presses one or more buttons on a game controller to instruct a game character to perform an action).

Given a set of one or more effectors, it is possible to use IK to derive (or calculate or determine), for one or more joints of the object 200, a corresponding joint angle, so that, when those joint angles are applied to their respective joints, the object 200 will satisfy (or at least try to satisfy) those effectors. The use of IK may, for example, aim to minimize a difference between a current configuration (e.g. position and/or orientation) for one or more joints of the object 200 and a configuration defined by the set of one or more effectors. IK is well-known in this field of technology and shall not be described in detail herein (see, for example, http://en.wikipedia.org/wiki/Inverse_kinematics, the entire disclosure of which is incorporated herein by reference). Thus, given a set of one or more effectors, the IK processing results in a “solution”, where that solution is a set of joint angles for one or more joints of the object 200. It will be appreciated that a set of effectors may be defined for which no solution can be obtained that satisfies all of the effectors in that set, such as when there are two conflicting effectors which cannot both be satisfied—in this case, the IK processing performed may use the above-mentioned weightings for the effectors to help resolve the effectors (e.g. derive joint angles so as to satisfy one effector and not another effector) in order to generate the solution. Similarly, for a given set of effectors there may be multiple different solutions which satisfy all of the effectors. For example, an effector for a right hand joint may be specified to move the right hand joint to a particular location in the virtual world 202 and an effector for a right shoulder joint may be specified to move the right shoulder joint to a particular location in the virtual world 202—both effectors can be satisfied whilst having the right elbow joint in different places.

There are many well-known numerical methods for solving inverse kinematics to obtain a set of joint angles which satisfy a set of effectors. Examples of such numerical methods include: cyclic coordinate descendent; step descendent optimization; Jacobian or pseudo-inverse methods; and Lagrange multipliers. It will be appreciated that any method of solving inverse kinematics may be used, including those examples listed.

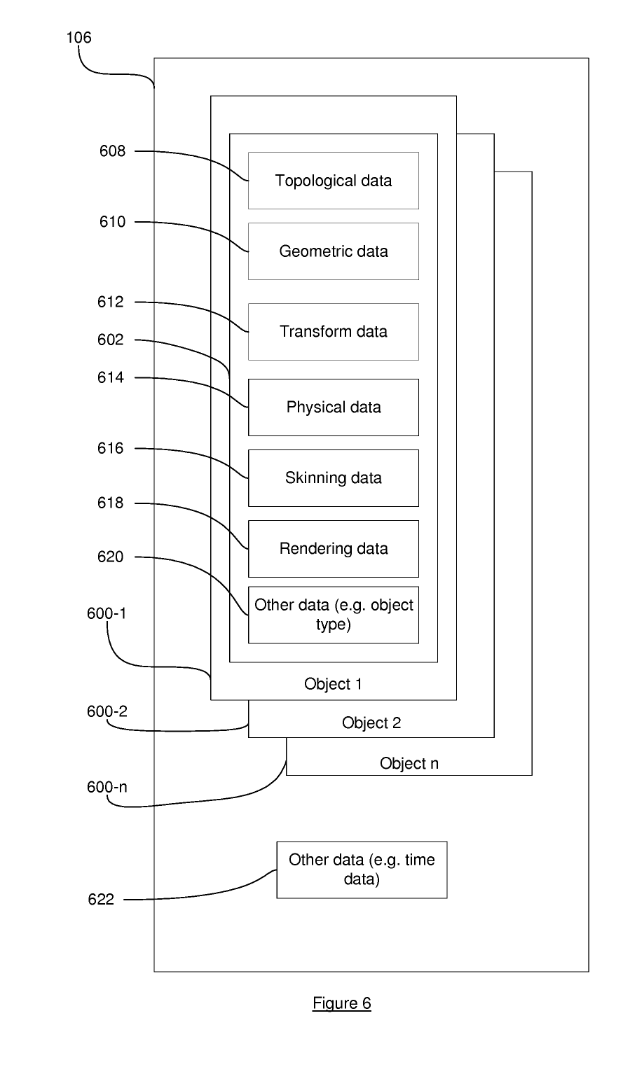

As shown in FIGS. 7A and 7B, a joint 700 has an associated frame 702 which shall be referred to as a “control frame” 702. Here, a “frame” defines a respective origin and set of axes (i.e. a frame of reference for that joint 700). This may also be viewed as a “frame” defining a respective location and orientation at that location. The control frame 702 may be defined with respect to a “world” frame for the entire virtual world 202 (which may be predetermined, at least for a current time point, or may be fixed or not fixed). However, it will be appreciated that the control frame 702 may be defined with respect to a frame fixed at the joint 700 or with respect to any other frame. The control frame 702 is not necessarily fixed within the frame that it is defined with respect to. However, the control frame 702 is at a known (or specified) position and orientation in the virtual world 202 relative to the joint 700. This position and orientation may be predetermined or fixed relative to the joint 700, although this need not be the case and may change from one update time point to another update time point. As such, movement of the joint 700 within the virtual world 202 causes the control frame 702 to be updated so as to maintain its position and orientation in the virtual world 202 relative to the joint 700. The control frame 702 may be considered as “rigidly” linked/attached to the joint 700.

In FIG. 7A, the control frame 702 may have its respective origin/location coincident with the position of the joint 700 within the virtual world 202 (as specified by the geometric data for the object 200). The orientation of the control frame 702 may also be the same as the orientation of the joint 700 (as specified by the geometric data for the object 200), but this need not be the case. As shown in FIG. 7B, the respective origin/location of the control frame 702 may be different from the position of the joint 700 within the virtual world 202 (as specified by the geometric data for the object 200).

An effector for the joint 700 may, then, be defined (or viewed) as a frame 704 in the virtual world 202, which shall be referred to as an “effector frame” 704 for the joint 700. Again, a “frame” defines a respective origin and set of axes (or frame of reference), and this may also be viewed as a “frame” defining a respective location and orientation at that location. Again, the effector frame 704 may be defined with respect to a predetermined frame, which may be a “world” frame for the entire virtual world 202 (which may be predetermined, at least for a current time point, or may be fixed or not fixed) or may be any other frame such as a frame fixed at the joint 700.

The application of IK to animate the object 200 may therefore involve updating the position and/or orientation of one or more joints of the object 200 so as to cause a movement of the joint 700 in the virtual world 202 that reduces the difference between the control frame 702 for that joint 700 and the effector frame 704 for that joint 700. Here, the “difference” between the control frame 702 and the effector frame 704 includes one or both of the distance between the respective origins/locations defined by the control frame 702 and the effector frame 704 and the difference between the respective orientations of the control frame 702 and the effector frame 704. Thus, reducing the difference between the control frame 702 and the effector frame 704 may involve one or both of: (a) reducing the distance between the respective origins/locations defined by the control frame 702 and the effector frame 704; and (b) reducing the difference between the respective orientations of the control frame 702 and the effector frame 704. The aim, then, of applying IK is that, for each joint 700 for which an effector has been defined, is to try to move that joint 700 within the virtual world 202 so that the control frame 702 for that joint 700 substantially coincides with the effector frame 704 for that joint (in terms of position and/or orientation).

### 4—BEHAVIOURS AND INVERSE KINEMATICS

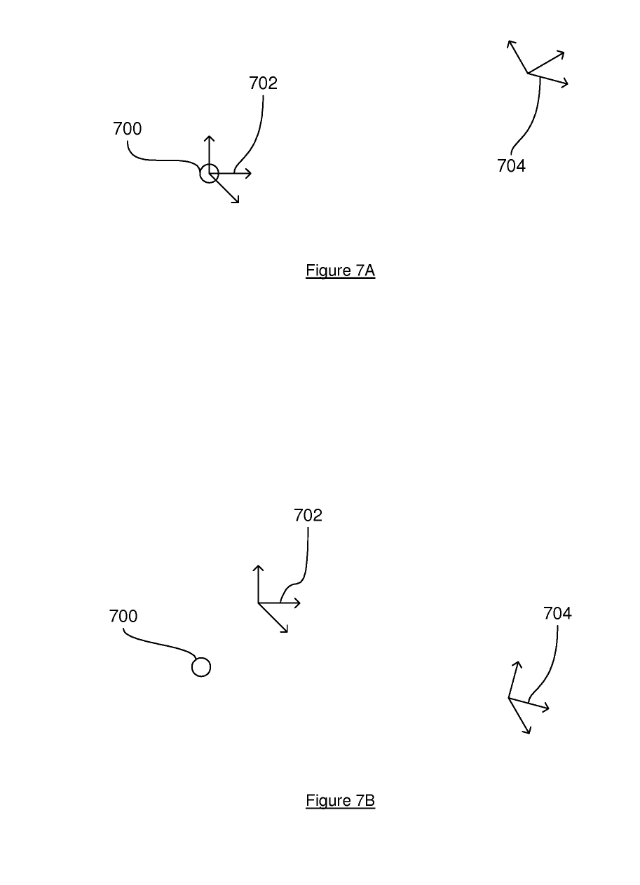

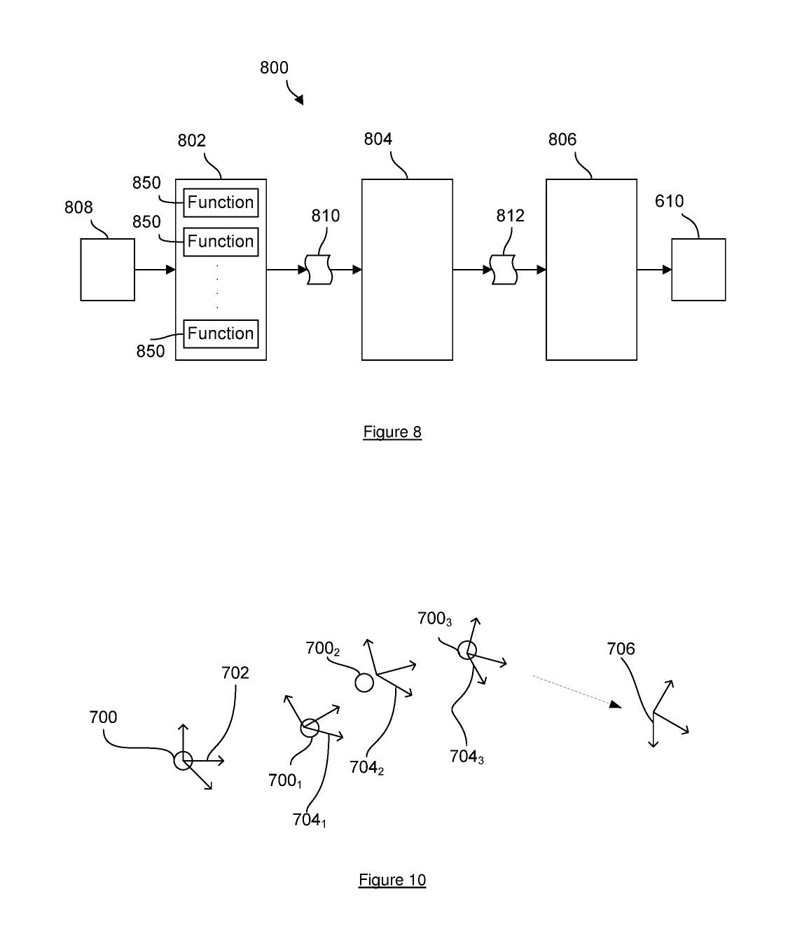

FIG. 8 schematically illustrates an example system 800 for animating a virtual object 200, according an embodiment. The system 800 may, for example, be implemented as one or more computer programs (or one or more software modules) and may, therefore, be executed by the processor 108 of the system 100 of FIG. 1.

The virtual world 202 may comprise a plurality of objects 200, and each object 200 may have its own corresponding system 800 implemented in order to animate that object 200. Alternatively, a system 800 may be used to animate a plurality of objects 200 (e.g. by sequentially or successively updating the configuration for a plurality of objects at an animation update step, or performing such updates in parallel for the plurality of objects). The description below therefore sets out how the system 800 may be used to animate a specific object 200 (with the same operations potentially being performed for other objects 200 in the virtual world 202).

The system 800 comprises a behaviour module 802, an effector generator module 804 and an IK module 806. In summary, the behaviour module 802 is arranged to receive a set of one or more input parameters 808 (or data or information) and to determine, from this set of input parameters 808, target data 810 for a virtual object 200. As shall become apparent, the target data 810 specifies (or defines) one or more targets (or goals or aims) for the object 200. The target data 810 is output from the behaviour module 802 and is received (or obtained/accessed) by the effector generator module 804. The effector generator module 804 is arranged to use the target data 810 to generate effector data 812—the effector data 812 specifies (or defines) one or more effectors (which may be referred to as “inertia effectors”) for one or more joints of the object 200 in order to try to achieve the one or more targets/goals specified by the target data 810. The effector data 812 is output from the effector generator module 804 and is received (or obtained/accessed) by the IK module 806. The IK module 806 then uses the effectors specified by the effector data 812 to perform IK processing to determine angles for one or more joints of the object 200, i.e. to update the geometric data 610 for the object 200 (as has been discussed above, and as is known in this field of technology).

Thus, the output of the behaviour module 802 (i.e. the target data 810) is not used as a direct input to the IK module 806—instead, as will become apparent, dynamics calculations are performed by the effector generator module 804 on the target data 810 to generate the effector data 812, and it is this effector data 812 that is used as the input to the IK module 806.

Each parameter in the set of one or more input parameters 808 may be an amount of data or a value representing a quantity intended to influence or control the behaviour (or animation or movement) of the object 200 for a next animation update step of the animation. The set of input parameters 808 may, therefore, include one or more parameters that are one or more of:
Inputs from a user (or some other controller of a game or animation tool). For example, the user inputs may identify a desired movement of the object 200, potentially including one or more properties of the movement such as a direction in which the object 200 is to move, a style in which the object 200 is to move, etc. (e.g. “move left”, “crouch”, “run at 70% of maximum running speed”, etc.).
One or more predetermined inputs (such as default animation data for the object 200).
Data indicating how the object 200 has interacted with the virtual environment 202. This data could include, for example, an indication that a part of the object 200 has collided, or made contact, with a part of its virtual world 202 (e.g. another object within the virtual world 202), or that the object 200 is approaching another object within the virtual world 202 (with the intention then being that the object 200 should then be animated to take an evasive or protective manoeuvre).
Other data or information about the state of the object 200 and/or the virtual world 202.

The behaviour module 802 comprises, or is arranged to execute, one or more predetermined functions 850. The predetermined functions 850 may each make use of one or more of the parameters from the set of input parameters 808 to influence how the object 200 is to be animated. The behaviour module 802 uses the outputs of the predetermined functions 850 to determine the target data 810 for the object 200.

The predetermined functions 850 may be viewed as “abilities” or “tasks” for the object 200. For example one or more of the following may be implemented for the behaviour module 802:
One predetermined function 850 may be arranged to try to control the object 200 so as to simulate how the object 200 would respond to being “wounded” (for example when the input parameters 808 indicate that the object 200 has been wounded). This may be achieved by setting a target (as specified in the target data 810) for an arm so that a hand joint at the end of the arm will be moved to cover, or be located at, the wound.
Another predetermined function 850 may be arranged to control the object 200 so as to try to cause the object 200 to remain in a balanced posture, for example by setting a target (as specified in the target data 810) for one or more feet joints of the object 200. Such a function may make use of input parameters 808 that specify the nature of the surface on which the object 200 is positioned, together with input parameters 808 specifying other influences that may be acting on the object 200.
Another predetermined function 850 could be arranged to control the object 200 to simulate the object 200 defending itself from an attack, such as by setting a target (as specified in the target data 810) for an arm or leg to move joints of that arm or leg to block or repel another object in the virtual world 202.
Another predetermined function 850 could be arranged to set a target (as specified in the target data 810) for a head of the object 200 to control a joint for the head so that the head remains oriented and facing towards a particular point or object within the virtual world 202.
Another predetermined function 850 could be to control the object 200 to simulate the character walking, running, or performing some other predetermined movement, by setting one or more targets (as specified in the target data 810) for corresponding parts of the object 200.
Another predetermined function 850 could be to control the object 200 to perform a predetermined interaction with another object in the virtual world 202 (such as pressing a button or picking up an object), by setting one or more targets (as specified in the target data 810) for corresponding parts of the object 200.
Another predetermined function 850 could be to control the object 200 to collide with another object in the virtual world 202 in a particular manner, by setting one or more targets (as specified in the target data 810) for corresponding parts of the object 200, such as by specifying a target location and a target velocity for the collision for one or more parts of the object 200.

Other abilities may, of course, be provided for by other predetermined functions 850. Indeed, the behaviour module 802 may be arranged to receive, as an input, animation data for (or defining) a predetermined animation (e.g. a “walk” animation or a “run” animation), and the behaviour module 802, or one of its predetermined functions 850, may be arranged to pass this animation (in the form of target data 810) to the effector generator module 804, i.e. one of the functions 850 may simply form one or more targets (as represented by the target data 810) to represent the predetermined animation.

Some of the predetermined functions 850 may be specific to a subset of joints or bones of the object 200, thereby outputting target data just in relation to those specific joints or bones; other predetermined functions 850 may determine target data for the whole object 200.

At any given animation update step, a predetermined function 850 may generate new target data to specify one or more targets for the object 200, or may not generate new target data. For example, if a predetermined function 850 is arranged to try to control the object 200 so as to simulate how the object 200 would respond to being “wounded” (for example when the input parameters 808 indicate that the object 200 has been wounded), then that predetermined function 850 may generate and output new target data if the input parameters 808 change to indicate that the object 200 has been wounded, whereas it might not generate and output new target data if the input parameters do not change to indicate that the object 200 has been wounded. Thus, at any given animation update step, the behaviour module 802 may generate new target data 810 to specify one or more targets for the object 200, or may not generate new target data 810.

By making use of individual predetermined functions 850, the behaviour module 802 is made modular, which makes it easier to add and extend different aspects of character behaviour. For example, if a new ability for the object 200 is to be implemented, such as an ability to point a hand (at the end of an arm limb) at a location or object within the virtual world 202, then a new predetermined function 850 for that ability may be created (in isolation) and added to the behaviour module 802 without affecting the already-existing predetermined functions 850. It will be appreciated, however, that the behaviour module 802 may be implemented itself as a single predetermined function 850 (albeit perhaps more complex and involved than the more modular approach set out above).

The behaviour module 802 takes the outputs from each predetermined function 850 and generates, or determines, the target data 810 for the object 200. Some of the predetermined functions 850 may each wish to control how a particular joint or bone is to be controlled or moved. For example, if the set of input parameters 808 indicates that the object 200 has received a wound and is also being attacked, then one of the predetermined functions 850 that responds to the object 200 being “wounded” may wish to move a hand joint to cover the wound, whilst another one of the predetermined functions 850 that responds to the object 200 being “attacked” may wish to move that same hand joint so as to defend the object 200 from the attack. The behaviour module 802 may arbitrate between the outputs of multiple predetermined functions 850 in order to generate the output target data 810. This arbitration can be achieved in any suitable way, such as: by forming the target data 810 using a weighted combination of the individual configurations/targets output by each of the predetermined functions 850; by ignoring individual configurations/targets output by some of the predetermined functions 850 (in preference of individual configurations/targets output by other predetermined functions 850) in certain circumstances; etc.

Hence, the output from the behaviour module 802 comprises target data 810 for the object 200. The target data 810 may take many different forms. In general, though, the target data 810 specifies, or defines, for one or more object parts (e.g. joints) of the object 200, a corresponding target. Thus, the target data 810 may comprise, for each of the targets, one or more target parameters that define or specify that target. The target parameters for a target for an object part may comprise (or indicate/define), for example, one or more of:
A target location for that object part. This target location may be a desired/intended location at which that object part should become located at some animation update step (whether the current animation update step or a future animation update step). This location may be specified, for example, in a frame for the virtual world 202 for example, if the behaviour module 802 wishes to move a hand joint of the object 200 to a particular location within the virtual world 202 (e.g. to press a button or pick up another object), that that location may be specified in a frame for the virtual world 202. Alternatively, the location may be specified, for example, in a frame for the object 200 (e.g. a frame for a root joint or a trajectory joint for the object 200)—this could be used in the above example of moving the hand joint to a particular location within the virtual world 202, but with that location specified relative to the object 200; this could also be used, for example, to move the hand joint to a particular location on the object 200 itself (for example, to move the hand joint to a shoulder of the object 200 in response to that shoulder being wounded). Alternatively, the location may be specified, for example, in a frame for the object part itself. It will be appreciated that other ways of specifying a target location for the object part may be used instead.
A target orientation (or angle of rotation) for that object part. This target orientation may be a desired/intended orientation which that object part should assume at some animation update step (whether the current animation update step or a future animation update step). In a similar manner to specifying the target location for the object part, the target orientation for the object part may be specified, for example, in a frame for the virtual world 202, in a frame for the object 200 (e.g. a frame for a root joint or a trajectory joint for the object 200), or in a frame for that object part. It will be appreciated that other ways of specifying a target orientation for the object part may be used instead.
One or more velocities, accelerations, or higher-order derivatives for the location and/or the orientation for that object part. These velocities, accelerations and higher-order derivatives may be desired/intended velocities, accelerations and higher-order derivatives to be assumed by the object part at some animation update step (whether the current animation update step or a future animation update step). Indeed, multiple velocities, accelerations and/or higher-order derivatives may be specified for the location and/or the orientation for that object part—for example, an initial velocity may be specified for the object part (for the current animation update step) and a final velocity may be specified for the object part (which is an intended velocity that the object part should have when, for example, that object part is located at a target location specified by the target for the object part).
One or more dynamics parameters for the target, where these one or more dynamics parameters are for use in a dynamics calculation. The nature of the dynamics parameters and dynamics calculation shall be described in more detail later.

It will be appreciated that other types of target parameters may be used.

A target may comprise, or relate to, one or more components. For example, these one or more components may comprise: one or more coordinates (e.g. x, y and z coordinates) that specify or identify a location within the virtual world 202; and/or one or more angles that specify or identify an orientation within in the virtual world 202. Target parameters may be specified for each of these one or more components. For example, in relation to an x-coordinate, a location value, a speed value, an acceleration value, dynamics parameters, etc. may be defined for that x-coordinate and, the same applies equally to the other components for the target.

Each target may be defined by different combinations or sets of one or more corresponding target parameters—for example, a first target may be specified using location parameters, a second target may be specified using location and orientation parameters, a third target may be specified using orientation and velocity parameters, etc.

The target data 810 may, therefore, be viewed as specifying a target/desired configuration for the object 200 (or at least for one or more of the object parts of that object 200).

The target data 810 may explicitly identify a particular joint of the object 200 to which a corresponding target relates (e.g. a target for the joint 5 in FIG. 3). Alternatively, the target data 810 may associate a target with a name/tag of a joint (e.g. a target for the “left shoulder”)—the above-mentioned tag data may then subsequently be used (e.g. by the effector generator module 804) to identify the specific joint of the object 200 to which that target corresponds. For example, if the target data 810 associates a target with a name/tag of “left shoulder” and the tag data for the object 200 in FIG. 3 associates the name/tag “left shoulder” with the joint 5 in FIG. 3, then that target corresponds to the joint 5. This enables the behaviour module 802 to output target data 810 independent of the actual rig for the object 200.

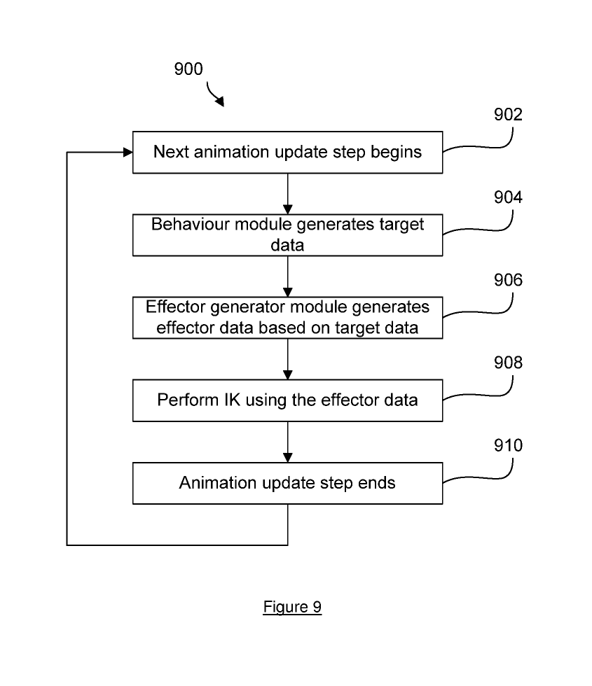

FIG. 9 is a flowchart illustrating a method 900 for animating an object 200 using the system 800 of FIG. 8 according to an embodiment.

At a step 902, a next animation update step (in the sequence/series of animation update steps) begins. This “next” animation update step is then the “current” animation update step.

At an optional step 904, the behaviour module 802 generates and outputs (or updates) the target data 810. For example, the behaviour module 802 may be arranged to generate (or determine) and output the target data 810 at each animation update step based on the current set of input parameters 808. However, this step 904 is optional because the behaviour module 802 may be arranged to generate and output (or update) the target data 810 at an animation update step only if there has been a change to the set of input parameters 808 since the preceding animation update step (in which case, the behaviour module 802 may be arranged to detect or determine whether there has been a change to the set of input parameters 808 for the current animation update step relative to the immediately preceding animation update step).

The actual generation of the target data 810 based on input parameters 808 that the behaviour module 802 receives (or accesses/obtains) has been described above.

The behaviour module 802 may store the target data 810, for example as part of the data 620 for the object 200—thus, if the behaviour module 802 generates new target data 810 at the current animation update step, then that new target data 810 is available as part of the data 620, whereas if the behaviour module 802 does not generate new target data 810 at the current animation update step, then previously generated target data 810 is available as part of the data 620. Additionally, or alternatively, the behaviour module 802 may provide the target data 810 to the effector generator module 804 (either at each animation update step, regardless of whether new target data 810 has been generated at the current animation update step, or only at an animation update step at which new target data 810 has been generated).

At a step 906, the effector generator module 804 receives (or obtains/accesses) the target data 810. As set out above, the effector generator module 804 may receive the target data 810 directly from the behaviour module 802 (potentially at each animation update step or only at an animation update step at which new target data 810 has been generated by the behaviour module 802). Alternatively, the effector generator module 804 may access stored target data 810 (e.g. from the data 620).

As mentioned above, the target data 810 specifies (or defines), for one or more object parts of the object 200, a corresponding target. At the step 906, for each of these one or more object parts for which a target has been defined, the effector generator module 804 performs a dynamics calculation to determine an effector for that object part—this dynamics calculation is based, at least in part, on the corresponding target for that object part. Methods for performing a dynamics calculation shall be set out in more detail shortly.

Thus, the effector generator module 804 generates the effector data 812 at the step 906. The effector generator module 804 may store the effector data 812, for example as part of the data 620 for the object 200. Additionally, or alternatively, the effector generator module 804 may provide the effector data 812 to the IK module 806.

At a step 908, the IK module 806 receives (or obtains/accesses) the effector data 812. As set out above, the IK module 806 may receive the effector data 812 directly from the effector generator module 804. Alternatively, the IK module 806 may access stored effector data 812 (e.g. from the data 620).

At the step 908, the IK module 806 performs an IK operation, based on the effector determined for each of the one of more object parts for which the target data 810 specified a target (i.e. based on the or each effector specified by the effector data 812). This IK operation updates a configuration for the object parts of the object 200, i.e. the IK operation updates the geometric data 610 for the object 200.

As discussed above, methods of performing IK operations are well known and shall not, therefore, be described in more detail herein.

At a step 910, the current animation update step ends. This may involve, for example, rendering an image representing the updated configuration of the object 200 (e.g. to depict the animation of the object 200 on the screen 120) and/or saving (or storing) data indicative of the update to the geometric data 610 for the object 200 (so that an animation of the object 200 can be rendered at a later point in time based on this stored data). Other processing may be performed (e.g. to update other data 622 for a game involving the object 200, the update being based on the updated configuration for the object 200, such as scoring game points or losing game lives or proceeding to a next stage in the game, etc).

Processing may then return to the step 902 in order to perform a further animation update step in the sequence of animation update steps.

Thus, the system 800 will determine, for one or more object parts of the object 200, a corresponding target and, at each animation update step of a sequence of one or more animation update steps: for each of the one or more object parts, perform a dynamics calculation to determine an effector for that object part, the dynamics calculation based, at least in part, on the corresponding target for that object part; and perform an inverse kinematics operation, based on the effector determined for each of the one of more object parts, to update a configuration for the plurality of object parts of the object 200. These one or more animation update steps are animation update steps that (a) include the animation update step at which target(s) is/are determined and target data 810 specifying the determined targets is generated and (b) zero or more subsequent animation update steps. Once new target data 810 is generated by the behavior module 802, then the targets specified by that new target data 810 may relate to some or all of the same object parts as the previous target data 810 (in which case the targets specified by the new target data 810 for these object parts may or may not be the same as the targets specified by the previous target data 810 for these object parts) and/or may relate to different object parts from those for the previous target data 810, and the effector generator module 804 will perform its dynamics calculations based, at least in part, on the targets specified by the new target data 810.

FIG. 10 schematically illustrates an example of the application of the method 900 in respect of a joint 700 of the object 200.

As shown in FIG. 10 (and as described above with reference to FIG. 7) the joint 700 has a control frame 702. Then:
At a first animation update step, the behaviour module 802 may define a target 706 for the joint 700. In FIG. 706, the target 706 is illustrated as a frame that defines a respective origin and set of axes (i.e. a frame of reference). This may also be viewed as the target 706 having target parameters that defining a location and an orientation at that location. At the first animation update step, the effector generator module 804 generates an effector for the joint 700 (shown in FIG. 10 as an effector frame 704₁) based on the target 706. The IK module 806, upon performing its IK operation, updates the geometric data 610 for the object 200. The new location for the joint 700 is shown in FIG. 10 as location 700₁ (the orientation for the joint 700 is not shown for the sake of clarity in FIG. 10).
At a next (second) animation update step, the target 706 for the joint 700 has not been updated by the behaviour module 802. Therefore, the effector generator module 804 generates a further effector for the joint 700 based on the target 706 (shown in FIG. 10 as an effector frame 704₂). The IK module 806, upon performing its IK operation, updates the geometric data 610 for the object 200. The new location for the joint 700 is shown in FIG. 10 as location 700₂ (the orientation for the joint 700 is not shown for the sake of clarity in FIG. 10).
At a next (third) animation update step, the target 706 for the joint 700 has not been updated by the behaviour module 802. Therefore, the effector generator module 804 generates a further effector for the joint 700 (shown in FIG. 10 as an effector frame 704₃) based on the target 706. The IK module 806, upon performing its IK operation, updates the geometric data 610 for the object 200. The new location for the joint 700 is shown in FIG. 10 as location 700₃ (the orientation for the joint 700 is now shown for the sake of clarity in FIG. 10).
This process may continue (as shown by the dashed arrow in FIG. 10). If the behaviour module 802 updates the target 706 for the joint 700, then the effector generation for the joint 700 is then based on the new target 706.

### 5—EFFECTOR GENERATION BY DYNAMICS CALCULATION

FIG. 11 schematically illustrates a method 1100, for performance by the effector generator module 804, for generating the effector data 812 based on the target data 810 according to an embodiment. The method 1100 is performed as part of the step 906 of the method 900 of FIG. 9.

At a step 1102, the effector generator module 804 receives (or obtains or accesses) the target data 810 (as has been discussed above).

At a step 1104, the effector generator module 804 determines whether there is a target specified by the target data 810 for which a corresponding effector has not been generated or determined yet at this current animation update step.

If, at the step 1104, the effector generator module 804 determines that there is not a target specified by the target data 810 for which a corresponding effector has not been generated yet at this current animation update step, then the method 1100 terminates at a step 1106 (since an effector will have been generated for each target specified by the target data 810); otherwise, if the effector generator module 804 determines that there is a target specified by the target data 810 for which a corresponding effector has not been generated yet at this current animation update step, the processing continues at a step 1108.

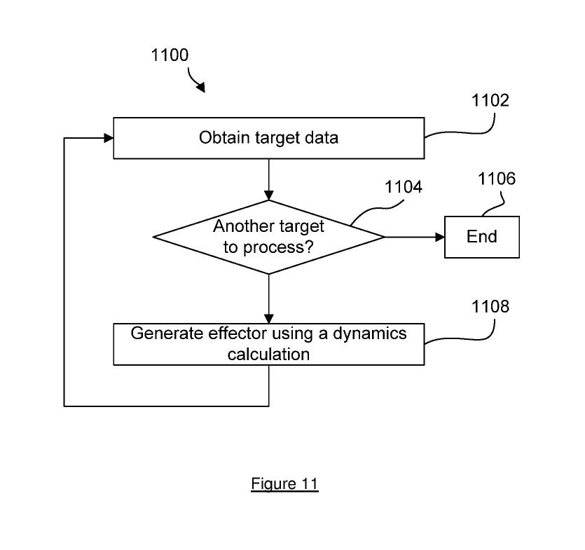

At the step 1108, the effector generator module 804 performs a dynamics calculation (described below with reference to FIG. 12) to generate or determine an effector for (or corresponding to) a target specified by the target data 810 for which a corresponding effector has not been generated yet at this current animation update step. The effector generator module 804 updates the effector data 812 to specify (or identify or indicate) the effector that has just been generated. Processing then returns to the step 1104.

Thus, when the step 1106 is reached during the current animation update step, the effector data 812 will be data that identifies, or specifies/defines, each of the effectors that has been determined when performing the step 1108 during the current animation update step.

FIG. 12 schematically illustrates a method 1200, for performance by the effector generator module 804, for performing a dynamics calculation in order to generate or determine an effector based on a target according to an embodiment. The method 1200 is performed as part of the step 1108 of the method 1100 of FIG. 11.

At a step 1202, the effector generator module 804 identifies the joint to which the target corresponds. As mentioned above, the target data 810 may explicitly identify a particular joint of the object 200 to which the target relates (e.g. a target for the joint 5 in FIG. 3). Alternatively, the target data 810 may associate a target with a name/tag of a joint (e.g. a target for the “left shoulder”), in which case the step 1202 may involve the effector generator module 804 using the tag data to identify the specific joint of the object 200 to which that target corresponds (for example, if the target data 810 associates a target with a name/tag of “left shoulder” and the tag data for the object 200 in FIG. 3 associates the name/tag “left shoulder” with the joint 5 in FIG. 3, then the effector generator module 804 may determine that the target corresponds to the joint 5).

The effector that is to be generated will comprise one or more components. For example, these one or more components may comprise: one or more coordinates (e.g. x, y and z coordinates) that specify or identify a location of the effector in the virtual world 202 (e.g. to specify the origin of an effector frame 704 for the effector); and/or one or more angles that specify or identify an orientation of the effector in the virtual world 202 (e.g. to specify the orientation of an effector frame 704 for the effector). As shall become apparent from the description below, the method 1200 may treat each component separately (e.g. the x-coordinate of the effector is determined independent of the y-coordinate of the effector, etc.). However, it will be appreciated that the calculation and processing set out below could be modified so that two or more components are calculated together, i.e. not independently of each other (e.g. the x-coordinate and the z-coordinate of the effector could be determined together so that they are dependent on each other, etc.). Therefore, embodiments are not limited to the example set out below in which each component of the effector is determined or derived separately/independently of the other components of the effector.

Thus, at a step 1204, the effector generator module 804 selects (or identifies) a next component to be generated for the effector. This may be viewed as determining whether there is another component for the effector that still needs to be determined (or calculated/generated). If all of the components of the effector have been generated, then processing continues at a step 1206, at which the method 1200 terminates; otherwise, processing continues at a step 1208.

At the step 1208, a dynamics calculation is performed to determine the value for the component of the effector selected at the step 1204. In the following, this component shall be illustrated as the x-coordinate (i.e. one of the coordinates specifying a location for the effector in the virtual world 202), but this is merely the sake of illustration and the description that follows for the step 1208 applies equally to any of the other components for the effector (e.g. y-coordinates and z-coordinate, and orientation angles).

In general, a dynamics calculation is a process that determines, or generates, an effector for a joint (or a value for one or more components of an effector for a joint), based not just on the target for that joint, but also based on: (a) one or more (simulated) dynamics, or physical, properties for, or associated with, that effector (or one or more dynamics/physical properties for, or associated with, the one or more components), such as a mass, a velocity, an acceleration, a higher-order derivative, etc.; and/or (b) one or more dynamics, or physical, parameters for, or associated with, that effector (or one or more dynamics/physical parameters for, or associated with, the one or more components), such as an angular frequency parameter, a damping ratio parameter, an spring constant for an oscillation, a damping coefficient, etc. A dynamics calculation may be (or may simulate) a physics/mechanics/kinematics process or calculation (which may be specified by one or more dynamics/physical parameters) to simulate movement of the effector (potentially in accordance with one or more dynamics/physical properties of the effector) within the virtual world 202. By associating dynamics/physical properties and/or dynamics/physical parameters with an effector (or with one or more components of the effector), and using these properties and/or parameters to determine or generate that effector (or one or more of its components), animation of the object 200 can be made more realistic (in comparison to performing IK animation without such dynamics calculations for the effectors) whilst also reducing (sometimes by a factor of 100) the processing time that might otherwise be required to generate equivalently realistic animations via other known animation techniques (such as dynamics animation which applies computationally-expensive physics engines to simulate the application of forces, torques, etc. to the object 200 in order animate the object 200). In particular, the use of such dynamics calculations in conjunction with IK processing can, for example, introduce more natural-looking aspects to an animation, such as: overshooting when a character reaches towards a target; lag at the beginning of a motion, thereby simulating a degree of inertia; smooth updates or transitions when a target changes; etc.

### Example Using Oscillator Functions

In the following example embodiment, the dynamics calculation performed at the step 1208 makes use of a so-called “oscillator function” (or a so-called “harmonic oscillator function”)—thus, the “oscillator function” is the above-mentioned physics/mechanics/kinematics process. Such oscillator functions (in the abstract) are well-known. In particular, an oscillator function simulates a restitution force F applied to an entity (which, in this embodiment, is the effector under consideration for the current performance of the method 1200), where this simulated restitution force F is based on a distance x for the entity and a velocity (or speed) v for the entity (in this case, an x-coordinate x of a location for the effector in the virtual world 202 and a corresponding x-coordinate v of a velocity for that effector in the virtual world 202). Here, the entity is assumed to have a mass m, (in this case, a simulated mass m for the effector or the corresponding joint, which may be specified as part of the physical data 614). In particular, the physics/mechanics/kinematics process being simulated for (or applied to) the effector can be represented by F=−kx−cv, where k is a spring constant (or stiffness) to simulate Hooke's law to provide a contribution Fₛ=−kx to the force F, and where c is a damping coefficient to simulate damping to provide a contribution F_{D}=−cv to the force F, so that F=Fₛ+F_{D}.

$$Since F = ma = m \frac{{d}^{2} x}{{dt}^{2}}$$

$$m \frac{{d}^{2} x}{{dt}^{2}} = - kx - cv \\ ⇒ \frac{{d}^{2} x}{{dt}^{2}} = - \frac{k}{m} x - \frac{c}{m} v \\ ⇒ \frac{{d}^{2} x}{{dt}^{2}} + \frac{c}{m} v + \frac{k}{m} x = 0 \\ ⇒ \frac{{d}^{2} x}{{dt}^{2}} + \frac{c}{m} \frac{dx}{dt} + \frac{k}{m} x = 0 ( since = \frac{dx}{dt} )$$

Define the angular frequency dynamics parameter w₀ by

$${w}_{0}^{2} = \frac{k}{m} ,$$

then

$$\frac{{d}^{2} x}{{dt}^{2}} + \frac{c}{m} \frac{dx}{dt} + {w}_{0}^{2} x = 0$$

$$Now , \frac{c}{m} = \frac{c \sqrt{k}}{\sqrt{m} \sqrt{m} \sqrt{k}} = \frac{c \sqrt{k / m}}{\sqrt{km}} = \frac{{cw}_{0}}{\sqrt{km}}$$

Define the damping ratio dynamics parameter L by

$$L = \frac{c}{2 \sqrt{km}} ,$$

so that

$$\frac{c}{m} = 2 {Lw}_{0}$$

Then the oscillator function can be written in terms of the damping ratio dynamics parameter L and the angular frequency dynamics parameter w₀ as follows:

$$\frac{{d}^{2} x}{{dt}^{2}} + 2 {Lw}_{0} \frac{dx}{dt} + {w}_{0}^{2} x = 0$$

Alternatively, the oscillator function can be written in terms of the spring constant k and the damping coefficient c as follows:

$$\frac{{d}^{2} x}{{dt}^{2}} + \frac{c}{m} \frac{dx}{dt} + \frac{k}{m} x = 0$$

More detail on oscillator functions and damping can be found at http://en.wikipedia.org/wiki/Damping, the entire disclosure of which is incorporated herein by reference.

As discussed above, a target for a joint may specify, or comprise, one or more dynamics parameters. In this embodiment, the target for a joint may specify, or comprise, the damping ratio dynamics parameter L and the angular frequency dynamics parameter w₀—in this case, the effector generator module 804 may determine the quantities

$$\frac{c}{m} = 2 {Lw}_{0} and \frac{k}{m} = {w}_{0}^{2} .$$

Alternatively, the target for a joint may specify, or comprise, the parameters k and c—in this case, the effector generator module 804 may determine the quantities

$$\frac{c}{m} and \frac{k}{m}$$

using the mass value m. It will be appreciated that each component of the effector may have its own corresponding damping ratio dynamics parameter L and angular frequency dynamics parameter w₀ (or, equivalently, its own values for the parameters k and c).

If the current animation update step is an animation update step at which the target parameters for the target are initially defined, or are updated, at the step 904 by the behaviour module 802, then the effector generator module 804 performs initialisation for the effector as follows:
A value x for this component of the effector is initialised to be a corresponding initial value x₀ (here, for the x-coordinate component, x₀ is an x-coordinate of a location or position). Thus, x=x₀. Here, x₀ may be the value of the corresponding coordinate of the current location of the joint (e.g. an x-coordinate for the current location of the joint in the virtual world 202), which the effector generator module 804 may obtain based on the geometric data 610. Alternatively, x₀ may be specified as part of target parameters that define the target.
A value v, representing a corresponding velocity (or speed, or first-order derivate of the value x) for this component of the effector is initialised to a value v₀, i.e. v=v₀. Here, v₀ may be a current speed value of the corresponding coordinate of the joint (e.g. the x-coordinate for the velocity of the joint in the virtual world 202), which the effector generator module 804 may obtain based on the geometric data 610 or other data 620. Alternatively, v₀ may be specified as part of target parameters that define the target. For example, specifying, as part of target parameters that define the target, a value of v₀ that is greater, or less, than the current value of the corresponding coordinate for the current velocity for the joint in the virtual world 202, results in the time that it takes the object 200 to actually achieve the target to be increased or decreased accordingly.
A value p is initialised to be a value p_{T} which is value of the corresponding component of the target (e.g. the x-coordinate of a target location or position in the virtual world 202 specified by the target, such as an x-coordinate for the origin of the frame 706 in FIG. 10), i.e. p=p_{T}.

The values x, v and p may be stored as part of the data 620 for the object 200.

If the current animation update step is not an animation update step at which the target parameters for the target are initially defined or updated at the step 904 by the behaviour module 802, then the effector generator module 804 will already have generated or determined values for x, v and p.

Regardless of whether the values for x, v and p are initialised during this step 1208, these values for x, v and p may be updated, with x and v being updated according to the oscillator function set out above. One way to achieve this (known as Verlet integration) is set out below, but it will be appreciated that other ways to solve the oscillator function (i.e. performing integration) to calculate updated values for x and v could be used instead (see, for example, http://gafferongames.com/game-physics/integration-basics/, the entire contents of which are incorporated herein by reference, which illustrates various integration techniques):
(1) Let Δt be an amount of time corresponding to the current animation update step (i.e. the amount of time that is meant to elapse within the animation due to the current animation update step, or an amount of time represented by the current animation update step). This value Δt may be a predetermined constant for the animation.
(2) Calculate or compute

$$a = - \frac{k}{m} ( x - p ) - \frac{c}{m} ( v - {v}_{T} ) .$$

Here, v_{T} is a target speed (or target first order derivative) value of the corresponding coordinate of the joint (e.g. the x-coordinate for a target/final velocity of the joint in the virtual world 202), intended for the joint to ultimately achieve. v_{T} may be a dynamics parameter forming part of the target parameters for this target, that the effector generator module 804 obtains (or receives or accesses) as part of the target data 810. Alternatively, v_{T} may assume a predetermined value, e.g. v_{T}=0.
(3) Update v so that it assumes a new value of v+aΔt.
(4) Update x so that it assumes a new value of x+vΔt.
(5) Update p so that it assumes a new value of p+v_{T}Δt.

The above use of v_{T} is to cater for scenarios in which the target intends the corresponding joint to achieve a desired target speed or velocity which can be set by the behaviour module 802 or which may be predetermined. However, in some embodiments, the intention is always to have the joint to achieve a zero-velocity (i.e. end up stationary) when it ultimately reaches a target location and/or orientation specified by the target—in such embodiments, the use of v_{T} may be ignored (i.e. a would be calculated or computed in step (1) as

$$a = - \frac{k}{m} ( x - p ) - \frac{c}{m} v ,$$

and step (5) would not be performed so that p would not be updated).

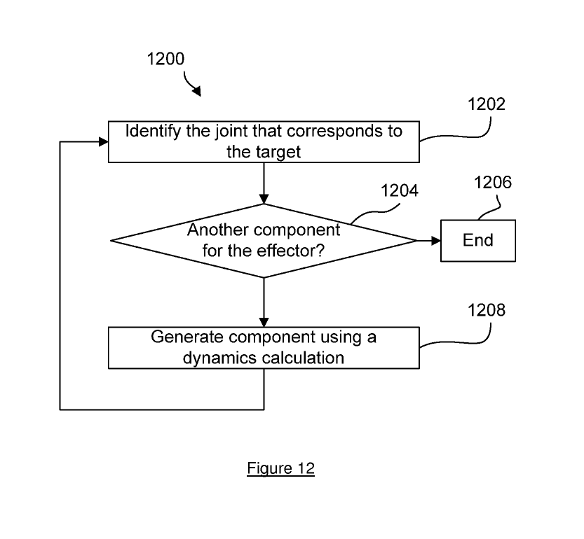

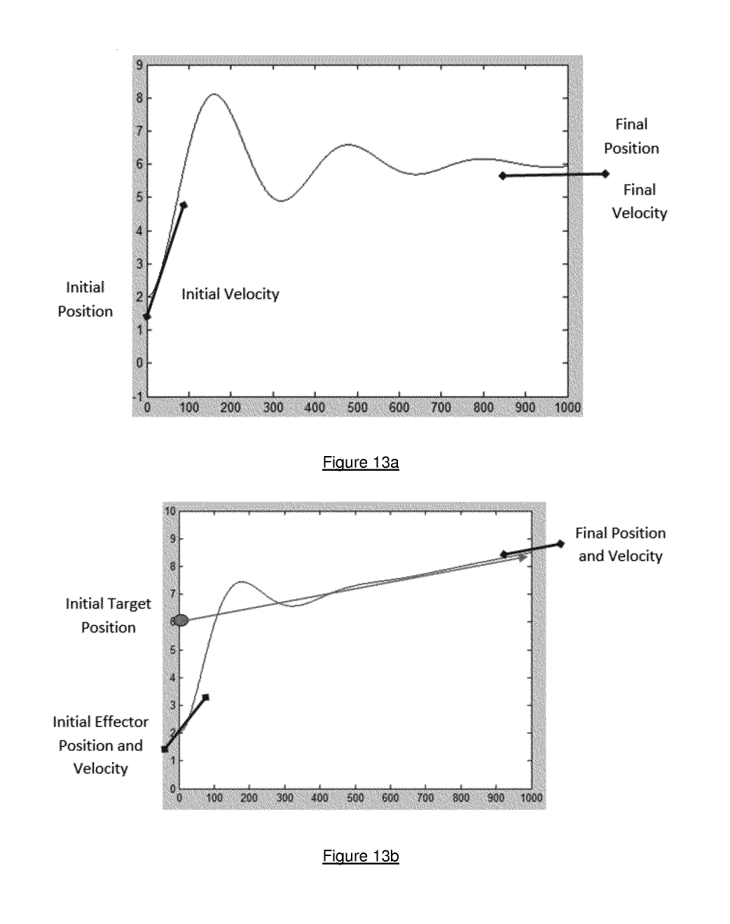

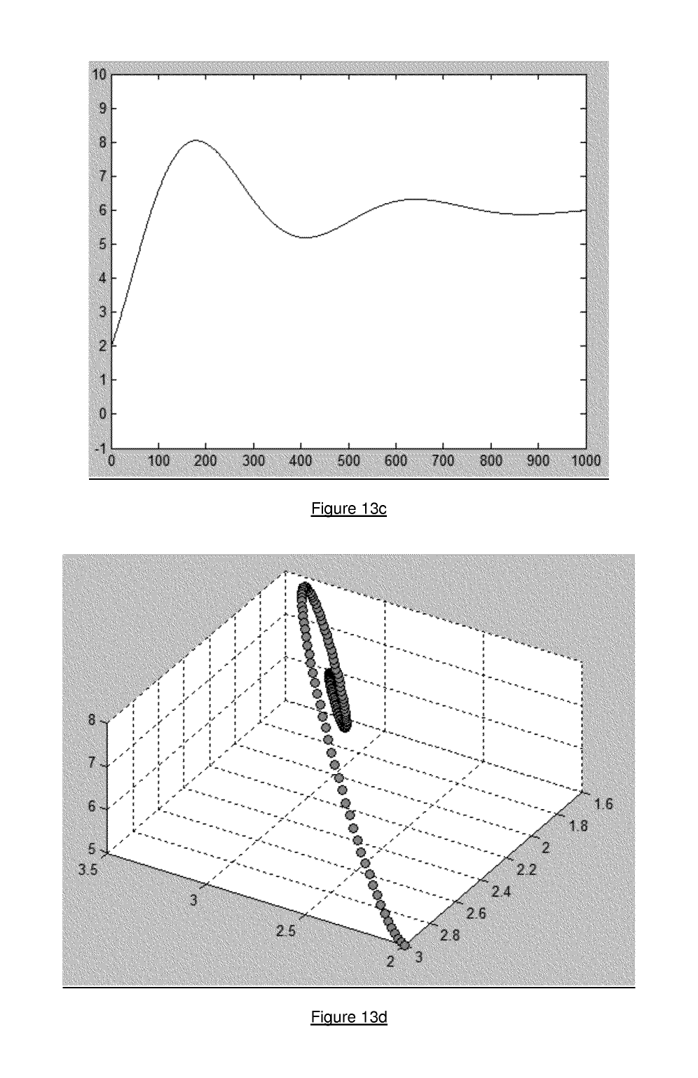

FIG. 13a is a graph showing an example of how the value of x may change, or be updated, using the above process. The horizontal axis represents an animation update step number (in this case, there are 1000 animation update steps which could, for example, represent 10 seconds of animation if there are 100 animation update steps per second). The vertical axis represents the value of x (i.e. the value assumed by the x-coordinate of the effector). In this example: x₀=2, p=6, v₀=0 and v_{T}=0. As can be seen, the x-coordinate of the effector approaches the target value of 6 (so that the associated joint moves towards the intended target location), but does so in a more natural way, rather than, say, simply moving linearly.

FIG. 13b is a similar graph to the one shown in FIG. 13a, except that this time v_{T}=1 instead. Thus, whilst the initial target position value was p=6, the target position is specified (by virtue of specifying v_{T}=1) to be moving (or at least have a moving x-component), so that at the end of the 1000 animation update steps, the target position has changed from 6 to 8.5. As can be seen, the effector has tracked this, so the x-coordinate of the effector approaches the moving target value and ends up having the target speed of v_{T}.

FIG. 13c is a similar graph to the one shown in FIG. 13a, except that this time v₀=2 instead. As can be seen, the slope of the graph in FIG. 13c is initially greater than the slope of the graph in FIG. 13a (representing a quicker response to try to have the effector reach the target sooner).

FIG. 13d is a 3-dimensional plot showing how the value of x, and also the corresponding y- and z-component values for the effector, may change, or be updated, using the above process.

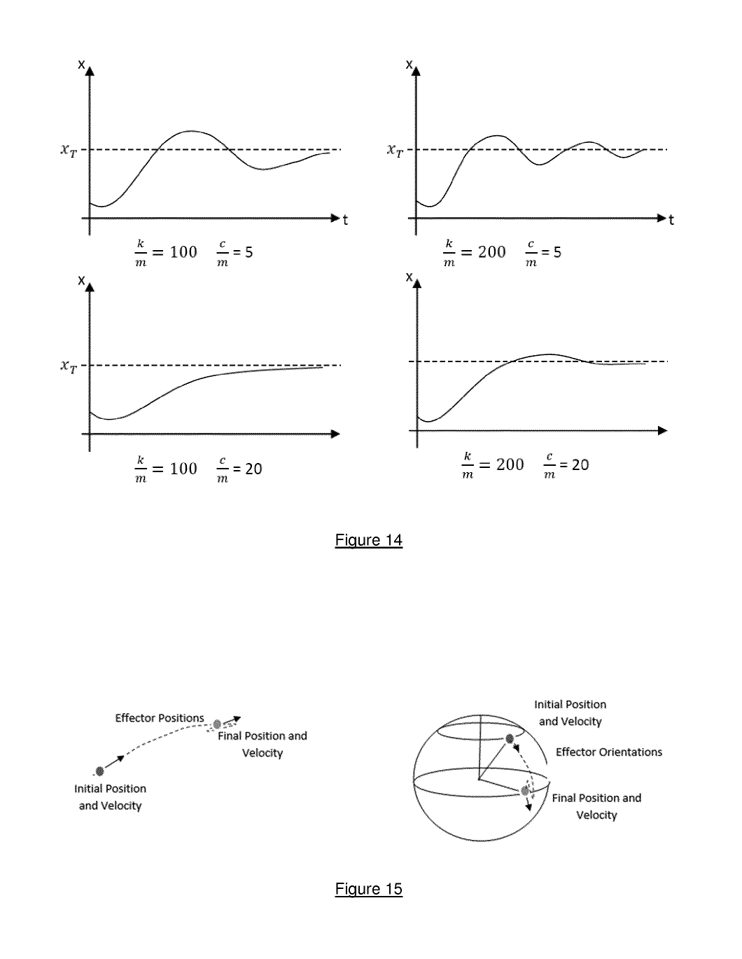

The value of the spring constant k affects how quickly the effector achieves/reaches the target location, sometimes referred to as lag (the greater the value of the spring constant k, the quicker the effector achieves/reaches the target location), and the behaviour module 802 may, therefore, set the spring constant k accordingly based on a desired effect/style/appearance for the animation/motion. The value of the damping coefficient c affects how the amount of overshoot (or amplitude and/or frequency of oscillation) for the effector achieving the target location (the lower the value of the damping coefficient c, the larger the overshoot), and the behaviour module 802 may, therefore, set the the damping coefficient c accordingly based on a desired effect/style/appearance for the animation/motion. FIG. 14 schematically illustrates how the spring constant k and the damping coefficient c affect the lag and overshoot.

Instead of specifying the spring constant k and the damping coefficient c, or specifying the damping ratio dynamics parameter L and the angular frequency dynamics parameter w₀, different target parameters may be specified from which the effector generator module 804 can then derive the spring constant k and the damping coefficient c, or the damping ratio dynamics parameter L and the angular frequency dynamics parameter w₀. These different target parameters, and their effects on the effector and the resulting animation, may be more “understandable” to a human animator (or designer/artist) than the spring constant k, the damping coefficient c, the damping ratio dynamics parameter L and the angular frequency dynamics parameter w₀, and therefore may help the human animator more easily configure an animation (or configure the behaviour module 805 or one of the functions 850).

Thus, the behaviour module 802 may be configured (e.g. by the animator) so that the target data 810 comprises one or more dynamics parameters from which the spring constant k and the damping coefficient c may be obtained by the effector generator module 804.

This could be achieved, for example, by the effector generator module 804 using a look-up table that stores values for the spring constant k and the damping coefficient c, and looking up values for the spring constant k and the damping coefficient c from this look-up table based on these one or more dynamics parameters in the target data 810 (with this potentially involving interpolating one or more values from the look-up table depending on these one or more dynamics parameters in the target data 810).

Alternatively, this could be achieved by the effector generator module 804 calculating, or determining, one or both of the spring constant k and the damping coefficient c based on these one or more dynamics parameters in the target data 810. For example:
The behaviour module 802 may be configured (e.g. by the animator) so that the target data 810 comprises a dynamics parameter D that represents an estimate, or approximation, of how long (in time or animation update steps) it takes for the corresponding effector to reach the target (i.e. a time lag). For a simple oscillator, the time T to complete the first cycle is related to the frequency by

$${w}_{0} = \frac{2 π}{T} .$$

Thus, the time to complete half an oscillation (i.e. for the curves of, for example, FIGS. 13a, 13b, 13c and 14, to reach their highest point) is

$$\frac{π}{{w}_{0}}$$

and, therefore, the dynamics parameter D may be considered to be equal to

$$\frac{π}{{w}_{0}} ,$$

so that

$${w}_{0} = \frac{π}{D} .$$

In this case, then, the value for the spring constant k may be calculated by the effector generator module 804 according to

$$k = {mw}_{0}^{2} = {m ( \frac{π}{D} )}^{2} .$$

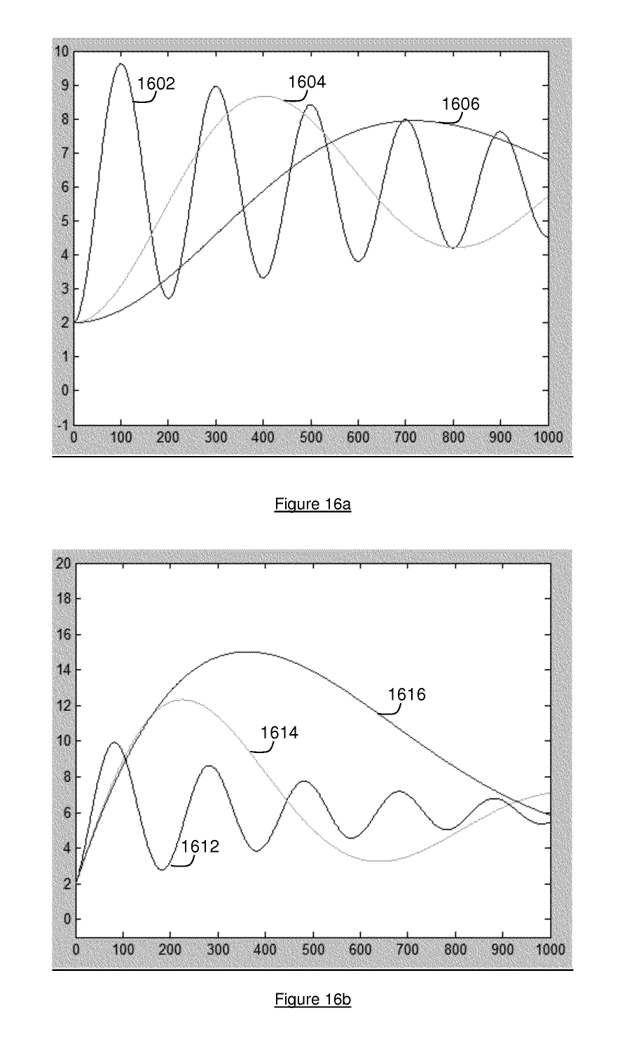

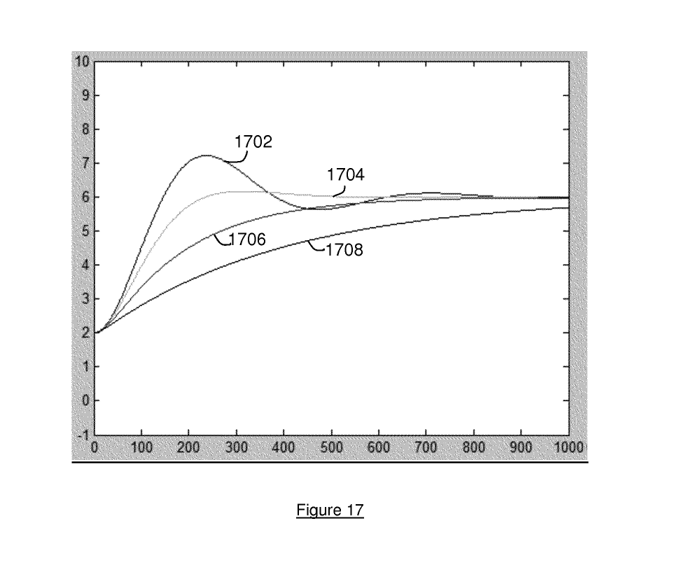

The greater the value of D, then longer it takes for the effector to reach the target. This is, therefore, a more readily understood dynamics parameter for the animator to understand. The value of the damping coefficient c may be determined/calculated by another method, or may assume a predetermined value.
FIG. 16a schematically illustrates the effect of the dynamics parameter D (where c=0.2, m=2, v₀=0). The plot 1602 corresponds to D=1; the plot 1604 corresponds to D=4; the plot 1606 corresponds to D=8. FIG. 16b schematically illustrates the effect of the dynamics parameter D (where c=0.2, m=2, v₀=8). The plot 1612 corresponds to D=1; the plot 1614 corresponds to D=4; the plot 1616 corresponds to D=8.
The behaviour module 802 may be configured (e.g. by the animator) so that the target data 810 comprises a “time lag” dynamics parameter L where

$$L = \frac{c}{k} .$$

The dynamics parameter L can be used to control how fast the effector reaches the target. The effector generator module 804 may be arranged to use a known value for one of the spring constant k and the damping coefficient c—this known value may be predetermined or may have been calculated via another technique (e.g. calculation of the spring constant k using the dynamics parameter D above). Then, based on the dynamics parameter L, the other one of the spring constant k and the damping coefficient c can be calculated. For example, if c is known, then k can be calculated as

$$k = \frac{c}{L} .$$

FIG. 17 schematically illustrates the effect of the dynamics parameter for a known value for k of 4 (so that c is calculated as c=kL. The plot 1702 corresponds to L=0.5, so that c=2; the plot 1704 corresponds to L=1, so that c=4; the plot 1706 corresponds to L=2, so that c=8; the plot 1708 corresponds to L=4, so that c=16. As can be seen, the greater the value of L, then longer it takes for the effector to reach the target. This is, therefore, a more readily understood dynamics parameter for the animator to understand.

As mentioned above, this example has been described with reference to x-coordinate components of an effector and a target. The same applies analogously to other components (such as y-coordinate, z-coordinate and orientation angle) of an effector and a target. For example, FIG. 15 illustrates (on the left) an example of how the value for an effector's x, y or z coordinate may change over a sequence of animation update steps, and also illustrates (on the right) an example of how the value for an orientation angle of an effector may change over a sequence of animation update steps.

### Other Dynamics Calculations

The above example made use of the so-called “oscillator function”, which is a specific second-order differential equation

$$\frac{{d}^{2} x}{{dt}^{2}} + 2 {Lw}_{0} \frac{dx}{dt} + {w}_{0}^{2} x = 0.$$

Embodiments may make use of different dynamics calculations that are based on different equations (which may be of higher or lower orders) in order to simulate different dynamical or physical properties. Indeed, different types of dynamics calculations may be used for different components of an effector and, indeed, the target parameters for a target may specify the type of dynamics calculation(s) to use.

### 6—EXAMPLES

Various examples are set out below:

### Example 1

A method of animating a virtual object within a virtual world, the method comprising: obtaining, for one or more object parts of a virtual object, a corresponding target, the virtual object comprising a plurality of object parts; at each animation update step of a sequence of one or more animation update steps: for each of the one or more object parts, performing a corresponding dynamics calculation to determine a corresponding effector for that object part, the dynamics calculation based, at least in part, on the corresponding target for that object part; and performing an inverse kinematics operation, based on the effector determined for each of the one of more object parts, to update a configuration for the plurality of object parts.

### Example 2

The method of example 1, wherein, for each object part of the one or more object parts, the corresponding target specifies one or more of: a location for that object part; an orientation for that object part; a velocity for that object part; an acceleration for that object part; one or more dynamics parameters for the corresponding dynamics calculation for that object part.

### Example 3

The method of example 1 or 2, wherein, for at least one object part of the one or more object parts, the corresponding dynamics calculation for said at least one object part is further based, at least in part, on one or more dynamics properties for the effector for said at least one object part.

### Example 4

The method of example 3, wherein the one or more dynamics properties for the effector comprise one or more of: a mass for that effector; a velocity for that effector; an acceleration for that effector.

### Example 5

The method of any one of examples 1-4, wherein, for at least one object part of the one or more object parts, the corresponding dynamics calculation for said at least one object part is further based, at least in part, on one or more dynamics parameters for the effector for said at least one object part.

### Example 6

The method of example 5, wherein the one or more dynamics parameters for the effector comprise one or more of: a parameter specifying, at least in part, a physics process to be performed as part of the corresponding dynamics calculation; a parameter specifying an angular frequency; a parameter specifying a damping ratio; a parameter specifying a damping coefficient; a parameter specifying a spring constant; a parameter specifying a lag for motion of the object part within the virtual world; a parameter specifying an overshoot for motion of the object part within the virtual world.

### Example 7

The method of any one of examples 1-6, wherein, for each of the one or more object parts, performing the corresponding dynamics calculation comprises performing a corresponding physics process to simulate movement of the corresponding effector within the virtual world.

### Example 8

The method of any one of examples 1-7, wherein, for each of the one or more object parts, performing the corresponding dynamics calculation comprises using an oscillator function to simulate movement of the corresponding effector within the virtual world.

### Example 9

The method of any one of examples 1-8, wherein, for each of the one or more object parts, the corresponding effector comprises a plurality of components and performing the corresponding dynamics calculation comprises determining each of the components independently.

### Example 10

The method of any one of examples 1-9, comprising determining, for the one or more object parts, the corresponding target.

### Example 11

A system for animating a virtual object within a virtual world, the system comprising a processor configured to: obtain, for one or more object parts of a virtual object, a corresponding target, the virtual object comprising a plurality of object parts; at each animation update step of a sequence of one or more animation update steps: for each of the one or more object parts, perform a corresponding dynamics calculation to determine a corresponding effector for that object part, the dynamics calculation based, at least in part, on the corresponding target for that object part; and perform an inverse kinematics operation, based on the effector determined for each of the one of more object parts, to update a configuration for the plurality of object parts.

### Example 12

The system of example 11, wherein, for each object part of the one or more object parts, the corresponding target specifies one or more of: a location for that object part; an orientation for that object part; a velocity for that object part; an acceleration for that object part; one or more dynamics parameters for the corresponding dynamics calculation for that object part.

### Example 13

The system of example 11 or 12, wherein, for at least one object part of the one or more object parts, the corresponding dynamics calculation for said at least one object part is further based, at least in part, on one or more dynamics properties for the effector for said at least one object part.

### Example 14

The system of example 13, wherein the one or more dynamics properties for the effector comprise one or more of: a mass for that effector; a velocity for that effector; an acceleration for that effector.

### Example 15

The system of any one of examples 11 to 14, wherein, for at least one object part of the one or more object parts, the corresponding dynamics calculation for said at least one object part is further based, at least in part, on one or more dynamics parameters for the effector for said at least one object part.

### Example 16

The system of example 15, wherein the one or more dynamics parameters for the effector comprise one or more of: a parameter specifying, at least in part, a physics process to be performed as part of the corresponding dynamics calculation; a parameter specifying an angular frequency; a parameter specifying a damping ratio; a parameter specifying a damping coefficient; a parameter specifying a spring constant; a parameter specifying a lag for motion of the object part within the virtual world; a parameter specifying an overshoot for motion of the object part within the virtual world.

### Example 17

The system of any one of examples 11 to 16, wherein, for each of the one or more object parts, the processor is arranged to perform the corresponding dynamics calculation by performing a corresponding physics process to simulate movement of the corresponding effector within the virtual world.

### Example 18

The system of any one of examples 11 to 17, wherein, for each of the one or more object parts, the processor is arranged to perform the corresponding dynamics calculation by using an oscillator function to simulate movement of the corresponding effector within the virtual world.

### Example 19

The system of any one of examples 11 to 18, wherein, for each of the one or more object parts, the corresponding effector comprises a plurality of components and the system is arranged to perform the corresponding dynamics calculation by determining each of the components independently.

### Example 20

The system of any one of examples 11 to 19, wherein the system is arranged to determine, for the one or more object parts, the corresponding target.

### Example 21

A computer program which, when executed by a processor, causes the processor to carry out a method according to any one of examples 1 to 10.

### Example 22

A computer readable medium storing a computer program according to example 21.

### 7—MODIFICATIONS

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then one or more storage media and/or one or more transmission media storing or carrying the computer program form aspects of the invention. The computer program may have one or more program instructions, or program code, which, when executed by one or more processors (or one or more computers), carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, byte code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of animating a virtual object within a virtual world, the method comprising:
obtaining, for one or more object parts of a virtual object, a corresponding target, the virtual object comprising a plurality of object parts;
at each animation update step of a sequence of one or more animation update steps:
for each of the one or more object parts, performing a corresponding dynamics calculation to determine a corresponding effector for that object part, the dynamics calculation based, at least in part, on the corresponding target for that object part; and
performing an inverse kinematics operation, based on the effector determined for each of the one of more object parts, to update a configuration for the plurality of object parts.

2. The method of claim 1, wherein, for each object part of the one or more object parts, the corresponding target specifies one or more of:
a location for that object part;
an orientation for that object part;
a velocity for that object part;
an acceleration for that object part;
one or more dynamics parameters for the corresponding dynamics calculation for that object part.

3. The method of claim 1, wherein, for at least one object part of the one or more object parts, the corresponding dynamics calculation for said at least one object part is further based, at least in part, on one or more dynamics properties for the effector for said at least one object part.

4. The method of claim 3, wherein the one or more dynamics properties for the effector comprise one or more of:
a mass for that effector;
a velocity for that effector;
an acceleration for that effector.

5. The method of claim 1, wherein, for at least one object part of the one or more object parts, the corresponding dynamics calculation for said at least one object part is further based, at least in part, on one or more dynamics parameters for the effector for said at least one object part.

6. The method of claim 5, wherein the one or more dynamics parameters for the effector comprise one or more of:
a parameter specifying, at least in part, a physics process to be performed as part of the corresponding dynamics calculation;
a parameter specifying an angular frequency;
a parameter specifying a damping ratio;
a parameter specifying a damping coefficient;
a parameter specifying a spring constant;
a parameter specifying a lag for motion of the object part within the virtual world;
a parameter specifying an overshoot for motion of the object part within the virtual world.

7. The method of claim 1, wherein, for each of the one or more object parts, performing the corresponding dynamics calculation comprises performing a corresponding physics process to simulate movement of the corresponding effector within the virtual world.

8. The method of claim 1, wherein, for each of the one or more object parts, performing the corresponding dynamics calculation comprises using an oscillator function to simulate movement of the corresponding effector within the virtual world.

9. The method of claim 1, wherein, for each of the one or more object parts, the corresponding effector comprises a plurality of components and performing the corresponding dynamics calculation comprises determining each of the components independently.

10. The method of claim 1, comprising determining, for the one or more object parts, the corresponding target.

11. A system for animating a virtual object within a virtual world, the system comprising a processor configured to:
obtain, for one or more object parts of a virtual object, a corresponding target, the virtual object comprising a plurality of object parts;
at each animation update step of a sequence of one or more animation update steps:
for each of the one or more object parts, perform a corresponding dynamics calculation to determine a corresponding effector for that object part, the dynamics calculation based, at least in part, on the corresponding target for that object part; and
perform an inverse kinematics operation, based on the effector determined for each of the one of more object parts, to update a configuration for the plurality of object parts.

12. The system of claim 11, wherein, for each object part of the one or more object parts, the corresponding target specifies one or more of:
a location for that object part;
an orientation for that object part;
a velocity for that object part;
an acceleration for that object part;
one or more dynamics parameters for the corresponding dynamics calculation for that object part.

13. The system of claim 11, wherein, for at least one object part of the one or more object parts, the corresponding dynamics calculation for said at least one object part is further based, at least in part, on one or more dynamics properties for the effector for said at least one object part.

14. The system of claim 13, wherein the one or more dynamics properties for the effector comprise one or more of:
a mass for that effector;
a velocity for that effector;
an acceleration for that effector.

15. The system of claim 11, wherein, for at least one object part of the one or more object parts, the corresponding dynamics calculation for said at least one object part is further based, at least in part, on one or more dynamics parameters for the effector for said at least one object part.

16. The system of claim 15, wherein the one or more dynamics parameters for the effector comprise one or more of:
a parameter specifying, at least in part, a physics process to be performed as part of the corresponding dynamics calculation;
a parameter specifying an angular frequency;
a parameter specifying a damping ratio;
a parameter specifying a damping coefficient;
a parameter specifying a spring constant;
a parameter specifying a lag for motion of the object part within the virtual world;
a parameter specifying an overshoot for motion of the object part within the virtual world.

17. The system of claim 11, wherein, for each of the one or more object parts, the processor is arranged to perform the corresponding dynamics calculation by performing a corresponding physics process to simulate movement of the corresponding effector within the virtual world.

18. The system of claim 11, wherein, for each of the one or more object parts, the processor is arranged to perform the corresponding dynamics calculation by using an oscillator function to simulate movement of the corresponding effector within the virtual world.

19. The system of claim 11, wherein, for each of the one or more object parts, the corresponding effector comprises a plurality of components and the system is arranged to perform the corresponding dynamics calculation by determining each of the components independently.

20. (canceled)

21. (canceled)

22. A non-transient computer readable medium storing a computer program, which when executed by a processor of a computer, causes the processor to:
obtain, for one or more object parts of a virtual object, a corresponding target, the virtual object comprising a plurality of object parts;
at each animation update step of a sequence of one or more animation update steps:
for each of the one or more object parts, perform a corresponding dynamics calculation to determine a corresponding effector for that object part, the dynamics calculation based, at least in part, on the corresponding target for that object part; and
perform an inverse kinematics operation, based on the effector determined for each of the one of more object parts, to update a configuration for the plurality of object parts.
